(19) United States
(12) Patent Application Publication
(10) Pub. No.: US 2021/0206389 A1
(43) Pub. Date: Jul. 8, 2021

(54) PROVIDING DEVICE AND PATH PROVIDING METHOD THEREOF

(71) Applicant: LG Electronics Inc., Seoul (KR)

(72) Inventors: Sungmin KIM, Seoul (KR); Sujin KIM, Seoul (KR)

(21) Appl. No.: 17/036,774

(22) Filed: Sep. 29, 2020

(30) Foreign Application Priority Data
Jan. 6, 2020 (KR) PCT/KR2020/000179

(51) Int. Cl. B60W 60/00; H04W 4/024; G06K 9/00; G01C 21/00; B60W 30/09; G01C 21/34; B60W 50/02; B60W 30/14

(52) U.S. Cl. CPC B60W 60/0015; H04W 4/024; G06K 9/00798; G01C 21/3885; H04W 4/40; G01C 21/3407; B60W 50/0205; B60W 30/143; B60W 30/09

(57) ABSTRACT

A path providing device is configured to, based on sensing information, identify a lane in which the vehicle is located among a plurality of lanes of a road, determine an optimal path for guiding the vehicle from the identified lane, generate and transmit field-of-view information for autonomous driving, merge the field-of-view information with dynamic information related to a movable object located on the optimal path, and update the optimal path based on the dynamic information. The path providing device is further configured to, in response to an occurrence of a collision of the vehicle on the optimal path, generate an emergency path based on the field-of-view information to guide the vehicle along the emergency path.

### CROSS-REFERENCE TO RELATED APPLICATION

Pursuant to 35 U.S.C. § 119(a), this application claims the benefit of an earlier filing date of and the right of priority to International Application No. PCT/KR2020/000179, filed on Jan. 6, 2020, the contents of which are incorporated by reference herein in their entirety.

### TECHNICAL FIELD

The present disclosure relates to a path providing device that provides path information to a vehicle and a path providing method thereof.

### BACKGROUND

A vehicle may transport people or goods using kinetic energy. Representative examples of vehicles include automobiles and motorcycles.

For safety and convenience of a user who uses the vehicle, various sensors and devices may be provided in the vehicle, and the functions of the vehicle may be diversified.

The function of the vehicle may be divided into a convenience function for promoting the convenience of a driver and a safety function for promoting the safety of a driver and/or a pedestrian.

For example, the convenience function may be related to driver convenience, and include, for example, giving an infotainment (information+entertainment) function to the vehicle, supporting a partial autonomous driving function, or assisting the driver's vision such as night vision or blind spot. In some examples, the convenience function may include an active cruise control (ACC) function, a smart parking assist system (SPAS) function, a night vision (NV) function, a head up display (HUD) function, an around view monitor (AVM) function, and an adaptive headlight system (AHS) function, and the like.

The safety function may include a technology for securing the safety of the driver and/or the safety of a pedestrian such as a lane departure warning system (LDWS) function, a lane keeping assist system (LKAS) function, an autonomous emergency braking (AEB) function, and the like.

For convenience of a user using a vehicle, various types of sensors and electronic devices may be provided in the vehicle. For instance, a vehicle may include, for the convenience of the user's driving, an advanced driver assistance system (ADAS). In some cases, a vehicle may be an autonomous vehicle.

The advanced driving assist system (ADAS) may be improved by development of a technology for optimizing user's convenience and safety while driving a vehicle.

For example, in order to effectively transmit eHorizon (electronic Horizon) data to autonomous driving systems and infotainment systems, the EU OEM (European Union Original Equipment Manufacturing) Association has established a data specification and transmission method as a standard under the name “ADASIS (ADAS Interface Specification).”

In some cases, eHorizon software may be an element of the safety/ECO/convenience of autonomous vehicles under a connected environment.

### SUMMARY

The present disclosure describes a path providing device capable of providing field-of-view information for autonomous driving that enables autonomous driving, and a path providing method thereof.

The present disclosure also describes a path providing device capable of promoting the safety of passengers using field-of-view information for autonomous driving, and a path providing method thereof.

According to one aspect of the subject matter described in this application, a path providing device is configured to provide path information to a vehicle. The path providing device includes a telecommunication control unit configured to receive map information comprising a plurality of layers of data from a server, an interface unit configured to receive sensing information from one or more sensors disposed at the vehicle, where the sensing information includes an image received from an image sensor among the one or more sensors, and a processor. The processor is configured to, based on the sensing information, identify a lane in which the vehicle is located among a plurality of lanes of a road, determine an optimal path for guiding the vehicle from the identified lane, the optimal path comprising one or more lanes included in the map information, based on the sensing information and the optimal path, generate field-of-view information for autonomous driving, and transmit the field-of-view information to at least one of the server or an electrical component disposed at the vehicle, merge the field-of-view information with dynamic information related to a movable object located on the optimal path, and update the optimal path based on the dynamic information. The processor is configured to, in response to an occurrence of a collision of the vehicle on the optimal path, generate an emergency path based on the field-of-view information, the emergency path being different from the optimal path, and control the interface unit to guide the vehicle along the emergency path.

Implementations according to this aspect can include one or more of the following features. For example, the processor can be configured to be configured to determine at least one of a driving enabled direction and a driving disabled direction based on the collision, and generate the emergency path to guide the vehicle in the driving enabled direction. In some examples, the processor can be configured to, based on the collision, determine a failure sensor among the one or more sensors disposed at the vehicle, and determine the driving disabled direction based on failure sensing information received from the failure sensor.

In some examples, the processor can be configured to be configured to exclude the failure sensing information from the sensing information for generating the field-of-view information. In some examples, the processor can be configured to be configured to control the interface unit to restrict transmission of the failure sensing information from the failure sensor.

In some implementations, the processor can be configured to be configured to search for a road traffic law prescribed for the road on which the vehicle is driving, and generate the emergency path based on the road traffic law. In some examples, the processor can be configured to, based on the movable object being present within a predetermined range from the vehicle, generate the emergency path within a range that complies with the road traffic law, and based on the movable object not being present within the predetermined range from the vehicle, generate the emergency path regardless of the road traffic law.

In some implementations, the processor can be configured to be configured to set the emergency path to have a higher priority than the optimal path. In some examples, the processor can be configured to, based on the emergency path being generated, control the interface unit to cancel the optimal path that was previously transmitted.

In some implementations, the emergency path can include a control command for controlling at least one of a driving direction or a driving speed of the vehicle.

In some implementations, the processor can be configured to, based on the collision, select an emergency path sensor among the one or more sensors disposed at the vehicle, and generate the emergency path based on emergency sensing information generated by the emergency path sensor. In some examples, the processor can be configured to, based on the collision, divide a range of 360 degrees with respect to a point of the vehicle into a sensing enabled region and a sensing disabled region, and select the emergency path sensor based on the sensing enabled region. In some examples, the processor can be configured to be configured to determine a destination of the emergency path based on the emergency path sensor. In some examples, the processor can be configured to be configured to vary the emergency path sensor based on at least one of a location of the collision or an impact of the collision.

In some implementations, the processor can be configured to, based on the collision of the vehicle, identify an accident lane among the plurality of lanes of the road, and control the telecommunication control unit to output the dynamic information that indicates the accident lane. In some examples, the processor can be configured to, based on the collision of the vehicle, determine whether the vehicle is able to move to the emergency path, and based on determining that the vehicle is unable to move to the emergency path, control the telecommunication control unit to output the dynamic information that indicates the accident lane.

According to another aspect, a method for providing path information to a vehicle includes receiving map information comprising a plurality of layers of data from a server, receiving sensing information from one or more sensors disposed at the vehicle, where the sensing information includes an image received from an image sensor among the one or more sensors, based on the sensing information, identifying a lane in which the vehicle is located among a plurality of lanes of a road, determining an optimal path for guiding the vehicle from the identified lane, where the optimal path includes one or more lanes included in the map information, generating field-of-view information for autonomous driving based on the sensing information and the optimal path, and transmitting the field-of-view information to at least one of the server or an electrical component disposed at the vehicle, merging the field-of-view information with dynamic information related to a movable object located on the optimal path, updating the optimal path based on the dynamic information, in response to an occurrence of a collision of the vehicle on the optimal path, generating an emergency path based on the field-of-view information, where the emergency path is different from the optimal path, and controlling the vehicle to drive along the emergency path.

Implementations according to this aspect can include one or more of the following features. For example, generating the emergency path can include, based on the collision, determining at least one of a driving enabled direction or a driving disabled direction, and generating the emergency path to guide the vehicle in the driving enabled direction. In some examples, the method can further include, based on the collision, determining a failure sensor among the one or more sensors disposed at the vehicle, and determining the driving disabled direction based on failure sensing information received from the failure sensor. In some implementations, the method can further include excluding the failure sensing information from the sensing information for generating the field-of-view information.

In some implementations, the path providing device can provide a path in units of lanes based on a high-definition map, and extract a reliable sensor as an emergency path sensor in the event of a collision. The path providing device can generate an emergency path that can be driven by the emergency path sensor so as to move a vehicle to a safe location. Thus, in the event of an accident, the vehicle can be guided to a safe location in units of lanes to reduce the risk of a secondary accident occurrence. In some examples, the vehicle can be moved to a safe location even when the driver is unable to drive.

### BRIEF DESCRIPTION OF THE DRAWINGS

FIG. 1 is a view illustrating an appearance of an example vehicle.

FIG. 2 illustrates the vehicle viewed at various angles from an outside.

FIGS. 3 and 4 are views illustrating an inside of an example vehicle.

FIGS. 5 and 6 are views illustrating example objects.

FIG. 7 is a block diagram illustrating example components of a vehicle.

FIG. 8 is a conceptual view illustrating an example of an electronic horizon provider (EHP).

FIG. 9 is a block diagram illustrating the path providing device of FIG. 8 in more detail.

FIG. 10 is a conceptual view illustrating an example of eHorizon.

FIGS. 11A and 11B are conceptual views illustrating examples of a local dynamic map (LDM) and an advanced driver assistance system (ADAS) MAP.

FIGS. 12A and 12B are views illustrating examples of high-definition map data received by a path driving device.

FIG. 13 is a flowchart illustrating an example method performed by a path providing device to receive a high-definition map and generate field-of-view information for autonomous driving.

FIG. 14 is a flowchart of an example method for generating an emergency path by a path providing device.

FIGS. 15A and 15B are views illustrating examples of the method of FIG. 14.

FIG. 16 is a flowchart of an example method for determining at least one of a failure sensor or an emergency path sensor based on a collision of a vehicle.

FIG. 17 is a flowchart of an example method for using at least one of a failure sensor and an emergency path sensor.

FIG. 18 is a block diagram of an example of a path providing device configured to generate an emergency path.

### DETAILED DESCRIPTION

Hereinafter, one or more implementations disclosed herein will be described in detail with reference to the accompanying drawings, and the same or similar elements are designated with the same numeral references regardless of the numerals in the drawings and their redundant description will be omitted.

A vehicle can include various type of automobiles such as cars, motorcycles and the like. Hereinafter, the vehicle will be described based on a car.

The vehicle may include one or more of an internal combustion engine car having an engine as a power source, a hybrid vehicle having an engine and an electric motor as power sources, an electric vehicle having an electric motor as a power source, and the like.

In the following description, a left side of a vehicle refers to a left side in a driving direction of the vehicle, and a right side of the vehicle refers to a right side in the driving direction.

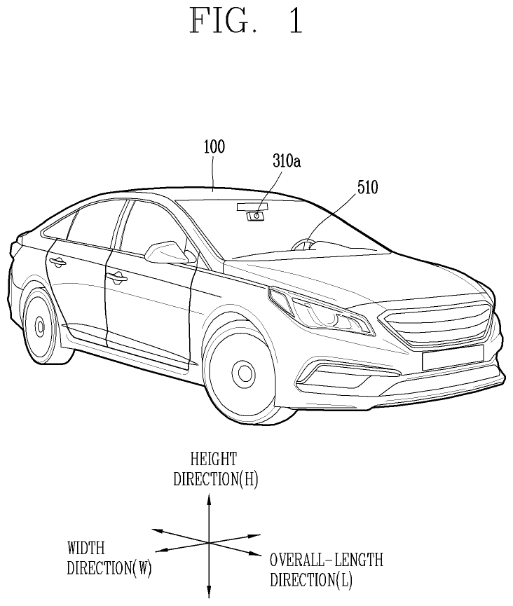

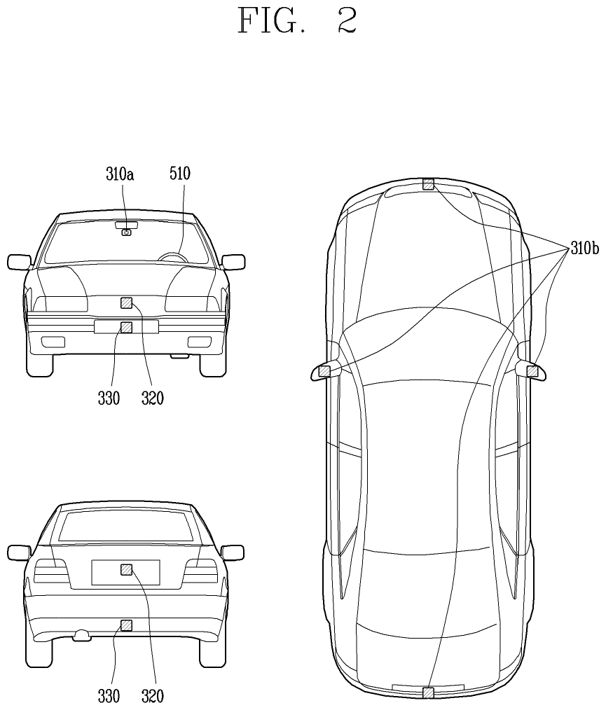

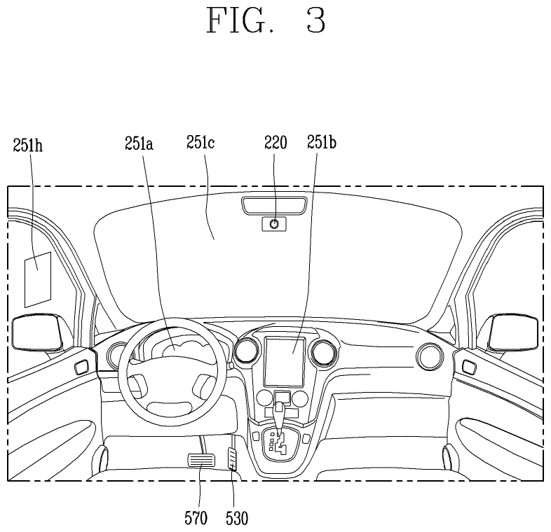

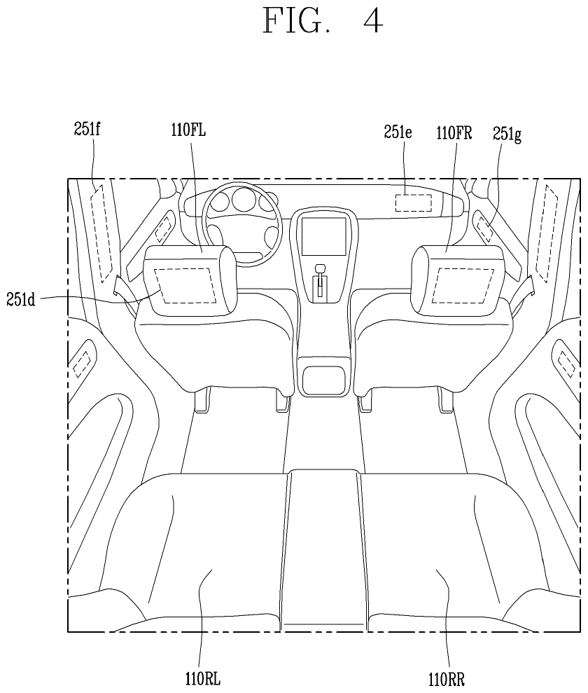

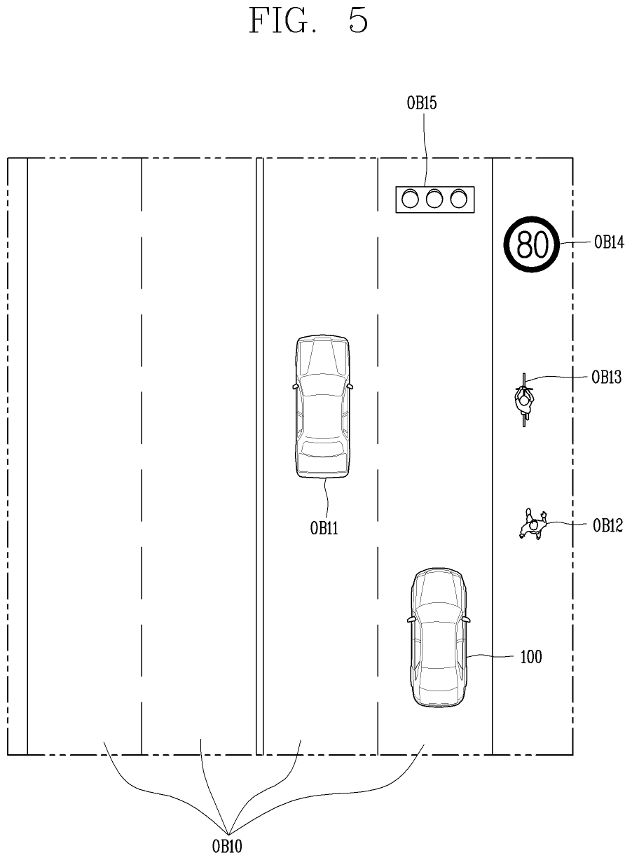

FIG. 1 illustrates an appearance of an example vehicle. FIG. 2 illustrates the vehicle at various angles from an outside. FIGS. 3 and 4 illustrate an inside of an example vehicle. FIGS. 5 and 6 illustrate example objects. FIG. 7 is a block diagram illustrating example components of a vehicle.

Referring to FIGS. 1 through 7, a vehicle 100 can include wheels turning by a driving force, and a steering input device 510 for adjusting a driving (ongoing, moving) direction of the vehicle 100.

The vehicle 100 can be an autonomous vehicle.

The vehicle 100 can be switched into an autonomous mode or a manual mode based on a user input.

For example, the vehicle can be converted from the manual mode into the autonomous mode or from the autonomous mode into the manual mode based on a user input received through a user interface apparatus 200.

The vehicle 100 can be switched into the autonomous mode or the manual mode based on driving environment information. The driving environment information can be generated based on object information provided from an object detecting apparatus 300.

For example, the vehicle 100 can be switched from the manual mode into the autonomous mode or from the autonomous module into the manual mode based on driving environment information generated in the object detecting apparatus 300.

In an example, the vehicle 100 can be switched from the manual mode into the autonomous mode or from the autonomous module into the manual mode based on driving environment information received through a communication apparatus 400.

The vehicle 100 can be switched from the manual mode into the autonomous mode or from the autonomous module into the manual mode based on information, data or signal provided from an external device.

When the vehicle 100 is driven in the autonomous mode, the autonomous vehicle 100 can be driven based on an operation system 700.

For example, the autonomous vehicle 100 can be driven based on information, data or signal generated in a driving system 710, a parking exit system 740 and a parking system 750.

When the vehicle 100 is driven in the manual mode, the autonomous vehicle 100 can receive a user input for driving through a driving control apparatus 500. The vehicle 100 can be driven based on the user input received through the driving control apparatus 500.

An overall length refers to a length from a front end to a rear end of the vehicle 100, a width refers to a width of the vehicle 100, and a height refers to a length from a bottom of a wheel to a roof. In the following description, an overall-length direction L can refer to a direction which is a criterion for measuring the overall length of the vehicle 100, a width direction W can refer to a direction that is a criterion for measuring a width of the vehicle 100, and a height direction H can refer to a direction that is a criterion for measuring a height of the vehicle 100.

As illustrated in FIG. 7, the vehicle 100 can include a user interface apparatus 200, an object detecting apparatus 300, a communication apparatus 400, a driving control apparatus 500, a vehicle operating apparatus 600, an operation system 700, a navigation system 770, a sensing unit 120, a vehicle interface unit 130, a memory 140, a controller 170 and a power supply unit 190.

In some implementations, the vehicle 100 can include more components in addition to components to be explained in this specification. In some examples, the vehicle 100 may not include some of the components explained in this specification.

The user interface apparatus 200 is an apparatus for communication between the vehicle 100 and a user. The user interface apparatus 200 can receive a user input and provide information generated in the vehicle 100 to the user. The vehicle 100 can implement user interfaces (UIs) or user experiences (UXs) through the user interface apparatus 200.

The user interface apparatus 200 can include an input unit 210, an internal camera 220, a biometric sensing unit 230, an output unit 250 and a processor 270.

In some implementations, the user interface apparatus 200 can include more components in addition to components to be explained in this specification. In some examples, the user interface apparatus 200 may not include some of the components explained in this specification.

The input unit 210 can allow the user to input information. Data collected in the input unit 210 can be analyzed by the processor 270 and processed as a user's control command.

The input unit 210 can be disposed within the vehicle. For example, the input unit 210 can be disposed on one area of a steering wheel, one area of an instrument panel, one area of a seat, one area of each pillar, one area of a door, one area of a center console, one area of a headlining, one area of a sun visor, one area of a wind shield, one area of a window or the like.

The input unit 210 can include a voice or audio input module 211, a gesture input module 212, a touch input module 213, and a mechanical input module 214.

The audio input module 211 can convert a user's voice input into an electric signal. The converted electric signal can be provided to the processor 270 or the controller 170.

The audio input module 211 can include at least one microphone.

The gesture input module 212 can convert a user's gesture input into an electric signal. The converted electric signal can be provided to the processor 270 or the controller 170.

The gesture input module 212 can include at least one of an infrared sensor and an image sensor for detecting the user's gesture input.

In some implementations, the gesture input module 212 can detect a user's three-dimensional (3D) gesture input. To this end, the gesture input module 212 can include a light emitting diode outputting a plurality of infrared rays or a plurality of image sensors.

The gesture input module 212 can detect the user's 3D gesture input by a time of flight (TOF) method, a structured light method or a disparity method.

The touch input module 213 can convert the user's touch input into an electric signal. The converted electric signal can be provided to the processor 270 or the controller 170.

The touch input module 213 can include a touch sensor for detecting the user's touch input.

In some implementations, the touch input module 213 can be integrated with the display module 251 so as to implement a touch screen. The touch screen can provide an input interface and an output interface between the vehicle 100 and the user.

The mechanical input module 214 can include at least one of a button, a dome switch, a jog wheel, and a jog switch. An electric signal generated by the mechanical input module 214 can be provided to the processor 270 or the controller 170.

The mechanical input module 214 can be arranged on a steering wheel, a center fascia, a center console, a cockpit module, a door and the like.

The internal camera 220 can acquire an internal image of the vehicle. The processor 270 can detect a user's state based on the internal image of the vehicle. The processor 270 can acquire information related to the user's gaze from the internal image of the vehicle. The processor 270 can detect a user gesture from the internal image of the vehicle.

The biometric sensing unit 230 can acquire the user's biometric information. The biometric sensing unit 230 can include a sensor for detecting the user's biometric information and acquire fingerprint information and heart rate information regarding the user using the sensor. The biometric information can be used for user authentication.

The output unit 250 can generate an output related to a visual, auditory or tactile signal.

The output unit 250 can include at least one of a display module 251, an audio output module 252 and a haptic output module 253.

The display module 251 can output graphic objects corresponding to various types of information.

The display module 251 can include at least one of a liquid crystal display (LCD), a thin film transistor-LCD (TFT LCD), an organic light-emitting diode (OLED), a flexible display, a three-dimensional (3D) display and an e-ink display.

The display module 251 can be inter-layered or integrated with a touch input module 213 to implement a touch screen.

The display module 251 can be implemented as a head up display (HUD). When the display module 251 is implemented as the HUD, the display module 251 can be provided with a projecting module so as to output information through an image which is projected on a windshield or a window.

The display module 251 can include a transparent display. The transparent display can be attached to the windshield or the window.

The transparent display can have a predetermined degree of transparency and output a predetermined screen thereon. The transparent display can include at least one of a transparent TFEL (Thin Film Electroluminescent), a transparent OLED (Organic Light-Emitting Diode), a transparent LCD (Liquid Crystal Display), a transmissive transparent display, and a transparent LED (Light Emitting Diode) display. The transparent display can have adjustable transparency.

In some implementations, the user interface apparatus 200 can include a plurality of display modules 251a to 251g.

The display module 251 can be disposed on one area of a steering wheel, one area 521a, 251b, 251e of an instrument panel, one area 251d of a seat, one area 251f of each pillar, one area 251g of a door, one area of a center console, one area of a headlining or one area of a sun visor, or implemented on one area 251c of a windshield or one area 251h of a window.

The audio output module 252 converts an electric signal provided from the processor 270 or the controller 170 into an audio signal for output. To this end, the audio output module 252 can include at least one speaker.

The haptic output module 253 generates a tactile output. For example, the haptic output module 253 can vibrate the steering wheel, a safety belt, a seat 110FL, 110FR, 110RL, 110RR such that the user can recognize such output.

The processor 270 can control an overall operation of each unit of the user interface apparatus 200.

In some implementations, the user interface apparatus 200 can include a plurality of processors 270. In other implementations, the user interface apparatus 200 may not include any processor 270.

In examples, where the processor 270 is not included in the user interface apparatus 200, the user interface apparatus 200 can operate according to a control of a processor of another apparatus within the vehicle 100 or the controller 170.

In some implementations, the user interface apparatus 200 can be called as a display apparatus for vehicle.

The user interface apparatus 200 can operate according to the control of the controller 170.

The object detecting apparatus 300 is an apparatus for detecting an object located at outside of the vehicle 100.

The object can be a variety of objects associated with driving (operation) of the vehicle 100.

Referring to FIGS. 5 and 6, an object O can include a traffic lane OB10, another vehicle OB11, a pedestrian OB12, a two-wheeled vehicle OB13, traffic signals OB14 and OB15, light, a road, a structure, a speed hump, a geographical feature, an animal and the like.

The lane OB01 can be a driving lane, a lane next to the driving lane or a lane on which another vehicle comes in an opposite direction to the vehicle 100. The lanes OB10 can be a concept including left and right lines forming a lane.

The another vehicle OB11 can be a vehicle which is moving around the vehicle 100. The another vehicle OB11 can be a vehicle located within a predetermined distance from the vehicle 100. For example, the another vehicle OB11 can be a vehicle which moves before or after the vehicle 100. In some examples, the vehicle 100 may be a first vehicle, and the vehicle OB11 may be a second vehicle.

The pedestrian OB12 can be a person located near the vehicle 100. The pedestrian OB12 can be a person located within a predetermined distance from the vehicle 100. For example, the pedestrian OB12 can be a person located on a sidewalk or roadway.

The two-wheeled vehicle OB13 can refer to a vehicle (transportation facility) that is located near the vehicle 100 and moves using two wheels. The two-wheeled vehicle OB13 can be a vehicle that is located within a predetermined distance from the vehicle 100 and has two wheels. For example, the two-wheeled vehicle OB13 can be a motorcycle or a bicycle that is located on a sidewalk or roadway.

The traffic signals can include a traffic light OB15, a traffic sign OB14 and a pattern or text drawn on a road surface.

The light can be light emitted from a lamp provided on another vehicle. The light can be light generated from a streetlamp. The light can be solar light.

The road can include a road surface, a curve, an upward slope, a downward slope and the like.

The structure can be an object that is located near a road and fixed on the ground. For example, the structure can include a streetlamp, a roadside tree, a building, an electric pole, a traffic light, a bridge and the like.

The geographical feature can include a mountain, a hill and the like.

In some implementations, objects can be classified into a moving object and a fixed object. For example, the moving object can be a concept including another vehicle and a pedestrian. The fixed object can be a concept including a traffic signal, a road and a structure.

The object detecting apparatus 300 can include a camera 310, a radar 320, a lidar 330, an ultrasonic sensor 340, an infrared sensor 350 and a processor 370.

In some implementations, the object detecting apparatus 300 can further include other components in addition to the components described. In some cases, the object detecting apparatus 300 may not include some of the components described.

The camera 310 can be located on an appropriate portion outside the vehicle to acquire an external image of the vehicle. The camera 310 can be a mono camera, a stereo camera 310a, an AVM (Around View Monitoring) camera 310b, or a 360-degree camera.

For example, the camera 310 can be disposed adjacent to a front windshield within the vehicle to acquire a front image of the vehicle. Or, the camera 310 can be disposed adjacent to a front bumper or a radiator grill.

For example, the camera 310 can be disposed adjacent to a rear glass within the vehicle to acquire a rear image of the vehicle. Or, the camera 310 can be disposed adjacent to a rear bumper, a trunk or a tail gate.

For example, the camera 310 can be disposed adjacent to at least one of side windows within the vehicle to acquire a side image of the vehicle. Or, the camera 310 can be disposed adjacent to a side mirror, a fender or a door.

The camera 310 can provide an acquired image to the processor 370.

The radar 320 can include electric wave transmitting and receiving portions. The radar 320 can be implemented as a pulse radar or a continuous wave radar according to a principle of emitting electric waves. The radar 320 can be implemented by a Frequency Modulated Continuous Wave (FMCW) scheme or a Frequency Shift Keying (FSK) scheme according to a signal waveform in a continuous wave radar scheme.

The radar 320 can detect an object in a time of flight (TOF) manner or a phase-shift manner through the medium of electromagnetic waves, and detect a position of the detected object, a distance from the detected object and a relative speed with the detected object.

The radar 320 can be disposed on an appropriate position outside the vehicle for detecting an object which is located at a front, rear or side of the vehicle.

The lidar 330 can include laser transmitting and receiving portions. The lidar 330 can be implemented in a time of flight (TOF) manner or a phase-shift manner.

The lidar 330 can be implemented as a drive type or a non-drive type.

For the drive type, the lidar 330 can be rotated by a motor and detect object near the vehicle 100.

For the non-drive type, the lidar 330 can detect, through light steering, objects which are located within a predetermined range based on the vehicle 100. The vehicle 100 can include a plurality of non-drive type lidars 330.

The lidar 330 can detect an object in a time of flight (TOF) manner or a phase-shift manner through the medium of laser light, and detect a position of the detected object, a distance from the detected object and a relative speed with the detected object.

The lidar 330 can be disposed on an appropriate position outside the vehicle for detecting an object located at the front, rear or side of the vehicle.

The ultrasonic sensor 340 can include ultrasonic wave transmitting and receiving portions. The ultrasonic sensor 340 can detect an object based on an ultrasonic wave, and detect a position of the detected object, a distance from the detected object and a relative speed with the detected object.

The ultrasonic sensor 340 can be disposed on an appropriate position outside the vehicle for detecting an object located at the front, rear or side of the vehicle.

The infrared sensor 350 can include infrared light transmitting and receiving portions. The infrared sensor 350 can detect an object based on infrared light, and detect a position of the detected object, a distance from the detected object and a relative speed with the detected object.

The infrared sensor 350 can be disposed on an appropriate position outside the vehicle for detecting an object located at the front, rear or side of the vehicle.

The processor 370 can control an overall operation of each unit of the object detecting apparatus 300.

The processor 370 can detect an object based on an acquired image, and track the object. The processor 370 can execute operations, such as a calculation of a distance from the object, a calculation of a relative speed with the object and the like, through an image processing algorithm.

The processor 370 can detect an object based on a reflected electromagnetic wave which an emitted electromagnetic wave is reflected from the object, and track the object. The processor 370 can execute operations, such as a calculation of a distance from the object, a calculation of a relative speed with the object and the like, based on the electromagnetic wave.

The processor 370 can detect an object based on a reflected laser beam which an emitted laser beam is reflected from the object, and track the object. The processor 370 can execute operations, such as a calculation of a distance from the object, a calculation of a relative speed with the object and the like, based on the laser beam.

The processor 370 can detect an object based on a reflected ultrasonic wave which an emitted ultrasonic wave is reflected from the object, and track the object. The processor 370 can execute operations, such as a calculation of a distance from the object, a calculation of a relative speed with the object and the like, based on the ultrasonic wave.

The processor 370 can detect an object based on reflected infrared light which emitted infrared light is reflected from the object, and track the object. The processor 370 can execute operations, such as a calculation of a distance from the object, a calculation of a relative speed with the object and the like, based on the infrared light.

In some implementations, the object detecting apparatus 300 can include a plurality of processors 370. In other implementations, the object detecting apparatus 300 may not include any processor 370. For example, each of the camera 310, the radar 320, the lidar 330, the ultrasonic sensor 340 and the infrared sensor 350 can include the processor in an individual manner.

When the processor 370 is not included in the object detecting apparatus 300, the object detecting apparatus 300 can operate according to the control of a processor of an apparatus within the vehicle 100 or the controller 170.

The object detecting apparatus 300 can operate according to the control of the controller 170.

The communication apparatus 400 is an apparatus for performing communication with an external device. Here, the external device can be another vehicle, a mobile terminal or a server.

The communication apparatus 400 can perform the communication by including at least one of a transmitting antenna, a receiving antenna, and radio frequency (RF) circuit and RF device for implementing various communication protocols.

The communication apparatus 400 can include a short-range communication unit 410, a location information unit 420, a V2X communication unit 430, an optical communication unit 440, a broadcast transceiver 450 and a processor 470.

In some implementations, the communication apparatus 400 can further include other components in addition to the components described. In some examples, the communication apparatus 400 may not include some of the components described.

The short-range communication unit 410 is a unit for facilitating short-range communications. Suitable technologies for implementing such short-range communications include Bluetooth, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication unit 410 can construct short-range area networks to perform short-range communication between the vehicle 100 and at least one external device.

The location information unit 420 is a unit for acquiring position information. For example, the location information unit 420 can include a Global Positioning System (GPS) module or a Differential Global Positioning System (DGPS) module.

The V2X communication unit 430 is a unit for performing wireless communications with a server (vehicle to infrastructure; V2I), another vehicle (vehicle to vehicle; V2V), or a pedestrian (vehicle to pedestrian; V2P). The V2X communication unit 430 can include an RF circuit capable of implementing a communication protocol with an infrastructure (V2I), a communication protocol between vehicles (V2V) and a communication protocol with a pedestrian (V2P).

The optical communication unit 440 is a unit for performing communication with an external device through the medium of light. The optical communication unit 440 can include a light-emitting diode for converting an electric signal into an optical signal and sending the optical signal to the exterior, and a photodiode for converting the received optical signal into an electric signal.

In some implementations, the light-emitting diode can be integrated with lamps provided on the vehicle 100.

The broadcast transceiver 450 is a unit for receiving a broadcast signal from an external broadcast managing entity or transmitting a broadcast signal to the broadcast managing entity via a broadcast channel. The broadcast channel can include a satellite channel, a terrestrial channel, or both. The broadcast signal can include a TV broadcast signal, a radio broadcast signal and a data broadcast signal.

The processor 470 can control an overall operation of each unit of the communication apparatus 400.

In some implementations, the communication apparatus 400 can include a plurality of processors 470. In some examples, the communication apparatus 400 may not include any processor 470.

In some examples, where the processor 470 is not included in the communication apparatus 400, the communication apparatus 400 can operate according to the control of a processor of another device within the vehicle 100 or the controller 170.

In some implementations, the communication apparatus 400 can implement a display apparatus for a vehicle together with the user interface apparatus 200. In this instance, the display apparatus for the vehicle can be referred to as a telematics apparatus or an Audio Video Navigation (AVN) apparatus.

The communication apparatus 400 can operate according to the control of the controller 170.

The driving control apparatus 500 is an apparatus for receiving a user input for driving.

In a manual mode, the vehicle 100 can be operated based on a signal provided by the driving control apparatus 500.

The driving control apparatus 500 can include a steering input device 510, an acceleration input device 530 and a brake input device 570.

The steering input device 510 can receive an input regarding a driving (ongoing) direction of the vehicle 100 from the user. In some implementations, the steering input device 510 can be configured in the form of a wheel allowing a steering input in a rotating manner. In some implementations, the steering input device can also be configured in a shape of a touch screen, a touchpad or a button.

The acceleration input device 530 can receive an input for accelerating the vehicle 100 from the user. The brake input device 570 can receive an input for braking the vehicle 100 from the user. Each of the acceleration input device 530 and the brake input device 570 can be configured in the form of a pedal. In some implementations, the acceleration input device or the brake input device can also be configured in the form of a touch screen, a touch pad or a button.

The driving control apparatus 500 can operate according to the control of the controller 170.

The vehicle operating apparatus 600 is an apparatus for electrically controlling operations of various devices within the vehicle 100.

The vehicle operating apparatus 600 can include a power train operating unit 610, a chassis operating unit 620, a door/window operating unit 630, a safety apparatus operating unit 640, a lamp operating unit 650, and an air-conditioner operating unit 660.

In some implementations, the vehicle operating apparatus 600 can further include other components in addition to the components described. In some cases, the vehicle operating apparatus 600 may not include some of the components described.

In some implementations, the vehicle operating apparatus 600 can include a processor. Each unit of the vehicle operating apparatus 600 can individually include a processor.

The power train operating unit 610 can control an operation of a power train device.

The power train operating unit 610 can include a power source operating portion 611 and a gearbox operating portion 612.

The power source operating portion 611 can perform a control for a power source of the vehicle 100.

For example, upon using a fossil fuel-based engine as the power source, the power source operating portion 611 can perform an electronic control for the engine. Accordingly, an output torque and the like of the engine can be controlled. The power source operating portion 611 can adjust the engine output torque according to the control of the controller 170.

For example, upon using an electric energy-based motor as the power source, the power source operating portion 611 can perform a control for the motor. The power source operating portion 611 can adjust a rotating speed, a torque and the like of the motor according to the control of the controller 170.

The gearbox operating portion 612 can perform a control for a gearbox.

The gearbox operating portion 612 can adjust a state of the gearbox. The gearbox operating portion 612 can change the state of the gearbox into drive (forward) (D), reverse (R), neutral (N) or parking (P).

In some implementations, when an engine is the power source, the gearbox operating portion 612 can adjust a locked state of a gear in the drive (D) state.

The chassis operating unit 620 can control an operation of a chassis device.

The chassis operating unit 620 can include a steering operating portion 621, a brake operating portion 622 and a suspension operating portion 623.

The steering operating portion 621 can perform an electronic control for a steering apparatus within the vehicle 100. The steering operating portion 621 can change a driving direction of the vehicle.

The brake operating portion 622 can perform an electronic control for a brake apparatus within the vehicle 100. For example, the brake operating portion 622 can control an operation of brakes provided at wheels to reduce speed of the vehicle 100.

In some implementations, the brake operating portion 622 can individually control each of a plurality of brakes. The brake operating portion 622 can differently control braking force applied to each of a plurality of wheels.

The suspension operating portion 623 can perform an electronic control for a suspension apparatus within the vehicle 100. For example, the suspension operating portion 623 can control the suspension apparatus to reduce vibration of the vehicle 100 when a bump is present on a road.

In some implementations, the suspension operating portion 623 can individually control each of a plurality of suspensions.

The door/window operating unit 630 can perform an electronic control for a door apparatus or a window apparatus within the vehicle 100.

The door/window operating unit 630 can include a door operating portion 631 and a window operating portion 632.

The door operating portion 631 can perform the control for the door apparatus. The door operating portion 631 can control opening or closing of a plurality of doors of the vehicle 100. The door operating portion 631 can control opening or closing of a trunk or a tail gate. The door operating portion 631 can control opening or closing of a sunroof.

The window operating portion 632 can perform the electronic control for the window apparatus. The window operating portion 632 can control opening or closing of a plurality of windows of the vehicle 100.

The safety apparatus operating unit 640 can perform an electronic control for various safety apparatuses within the vehicle 100.

The safety apparatus operating unit 640 can include an airbag operating portion 641, a seatbelt operating portion 642 and a pedestrian protecting apparatus operating portion 643.

The airbag operating portion 641 can perform an electronic control for an airbag apparatus within the vehicle 100. For example, the airbag operating portion 641 can control the airbag to be deployed upon a detection of a risk.

The seatbelt operating portion 642 can perform an electronic control for a seatbelt apparatus within the vehicle 100. For example, the seatbelt operating portion 642 can control passengers to be motionlessly seated in seats 110FL, 110FR, 110RL, 110RR using seatbelts upon a detection of a risk.

The pedestrian protecting apparatus operating portion 643 can perform an electronic control for a hood lift and a pedestrian airbag. For example, the pedestrian protecting apparatus operating portion 643 can control the hood lift and the pedestrian airbag to be open up upon detecting pedestrian collision.

The lamp operating unit 650 can perform an electronic control for various lamp apparatuses within the vehicle 100.

The air-conditioner operating unit 660 can perform an electronic control for an air conditioner within the vehicle 100. For example, the air-conditioner operating unit 660 can control the air conditioner to supply cold air into the vehicle when internal temperature of the vehicle is high.

The vehicle operating apparatus 600 can include a processor. Each unit of the vehicle operating apparatus 600 can individually include a processor.

The vehicle operating apparatus 600 can operate according to the control of the controller 170.

The operation system 700 is a system that controls various driving modes of the vehicle 100. The operation system 700 can be operated in the autonomous driving mode.

The operation system 700 can include a driving system 710, a parking exit system 740 and a parking system 750.

In some implementations, the operation system 700 can further include other components in addition to components to be described. In some examples, the operation system 700 may not include some of the components to be described.

In some implementations, the operation system 700 can include a processor. Each unit of the operation system 700 can individually include a processor.

In some implementations, the operation system can be a sub concept of the controller 170 when it is implemented in a software configuration.

In some implementations, the operation system 700 can be a concept including at least one of the user interface apparatus 200, the object detecting apparatus 300, the communication apparatus 400, the vehicle operating apparatus 600 and the controller 170.

The driving system 710 can perform driving of the vehicle 100.

The driving system 710 can receive navigation information from a navigation system 770, transmit a control signal to the vehicle operating apparatus 600, and perform driving of the vehicle 100.

The driving system 710 can receive object information from the object detecting apparatus 300, transmit a control signal to the vehicle operating apparatus 600 and perform driving of the vehicle 100.

The driving system 710 can receive a signal from an external device through the communication apparatus 400, transmit a control signal to the vehicle operating apparatus 600, and perform driving of the vehicle 100.

The parking exit system 740 can perform an exit of the vehicle 100 from a parking lot.

The parking exit system 740 can receive navigation information from the navigation system 770, transmit a control signal to the vehicle operating apparatus 600, and perform the exit of the vehicle 100 from the parking lot.

The parking exit system 740 can receive object information from the object detecting apparatus 300, transmit a control signal to the vehicle operating apparatus 600 and perform the exit of the vehicle 100 from the parking lot.

The parking exit system 740 can receive a signal from an external device through the communication apparatus 400, transmit a control signal to the vehicle operating apparatus 600, and perform the exit of the vehicle 100 from the parking lot.

The parking system 750 can perform parking of the vehicle 100.

The parking system 750 can receive navigation information from the navigation system 770, transmit a control signal to the vehicle operating apparatus 600, and park the vehicle 100.

The parking system 750 can receive object information from the object detecting apparatus 300, transmit a control signal to the vehicle operating apparatus 600 and park the vehicle 100.

The parking system 750 can receive a signal from an external device through the communication apparatus 400, transmit a control signal to the vehicle operating apparatus 600, and park the vehicle 100.

The navigation system 770 can provide navigation information. The navigation information can include at least one of map information, information regarding a set destination, path information according to the set destination, information regarding various objects on a path, lane information and current location information of the vehicle.

The navigation system 770 can include a memory and a processor. The memory can store the navigation information. The processor can control an operation of the navigation system 770.

In some implementations, the navigation system 770 can update prestored information by receiving information from an external device through the communication apparatus 400.

In some implementations, the navigation system 770 can be classified as a sub component of the user interface apparatus 200.

The sensing unit 120 can sense a status of the vehicle. The sensing unit 120 can include a posture sensor (e.g., a yaw sensor, a roll sensor, a pitch sensor, etc.), a collision sensor, a wheel sensor, a speed sensor, a tilt sensor, a weight-detecting sensor, a heading sensor, a gyro sensor, a position module, a vehicle forward/backward movement sensor, a battery sensor, a fuel sensor, a tire sensor, a steering sensor by a turn of a handle, a vehicle internal temperature sensor, a vehicle internal humidity sensor, an ultrasonic sensor, an illumination sensor, an accelerator position sensor, a brake pedal position sensor, and the like.

The sensing unit 120 can acquire sensing signals with respect to vehicle-related information, such as a posture, a collision, an orientation, a position (GPS information), an angle, a speed, an acceleration, a tilt, a forward/backward movement, a battery, a fuel, tires, lamps, internal temperature, internal humidity, a rotated angle of a steering wheel, external illumination, pressure applied to an accelerator, pressure applied to a brake pedal and the like.

The sensing unit 120 can further include an accelerator sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and the like.

The vehicle interface unit 130 can serve as a path allowing the vehicle 100 to interface with various types of external devices connected thereto. For example, the vehicle interface unit 130 can be provided with a port connectable with a mobile terminal, and connected to the mobile terminal through the port. In this instance, the vehicle interface unit 130 can exchange data with the mobile terminal.

In some implementations, the vehicle interface unit 130 can serve as a path for supplying electric energy to the connected mobile terminal. When the mobile terminal is electrically connected to the vehicle interface unit 130, the vehicle interface unit 130 supplies electric energy supplied from a power supply unit 190 to the mobile terminal according to the control of the controller 170.

The memory 140 is electrically connected to the controller 170. The memory 140 can store basic data for units, control data for controlling operations of units and input/output data. The memory 140 can be various storage apparatuses such as a ROM, a RAM, an EPROM, a flash drive, a hard drive, and the like in terms of hardware. The memory 140 can store various data for overall operations of the vehicle 100, such as programs for processing or controlling the controller 170.

In some implementations, the memory 140 can be integrated with the controller 170 or implemented as a sub component of the controller 170.

The controller 170 can control an overall operation of each unit of the vehicle 100. The controller 170 can be referred to as an Electronic Control Unit (ECU).

The power supply unit 190 can supply power required for an operation of each component according to the control of the controller 170. Specifically, the power supply unit 190 can receive power supplied from an internal battery of the vehicle, and the like.

At least one processor and the controller 170 included in the vehicle 100 can be implemented using at least one of application specific integrated circuits (ASICs), digital signal processors (DSPs), digital signal processing devices (DSPDs), programmable logic devices (PLDs), field programmable gate arrays (FPGAs), processors, controllers, micro controllers, microprocessors, and electric units performing other functions.

In some implementations, the vehicle 100 can include a path providing device 800.

The path providing device 800 can control at least one of those components illustrated in FIG. 7. From this perspective, the path providing device 800 can be the controller 170.

Without a limit to this, the path providing device 800 can be a separate device, independent of the controller 170. When the path providing device 800 is implemented as a component independent of the controller 170, the path providing device 800 can be provided on a part of the vehicle 100. In some examples, the path providing device 800 can include an electric circuit, a processor, a controller, a transceiver, or the like.

Hereinafter, description will be given of an example that the path providing device 800 is a component separate from the controller 170 for the sake of explanation. In this specification, functions (operations) and control methods described in relation to the path providing device 800 can be executed by the controller 170 of the vehicle. In other words, every detail described in relation to the path providing device 800 can be applied to the controller 170 in the same/like manner.

Furthermore, the path providing device 800 described herein can include some of the components illustrated in FIG. 7 and various components included in the vehicle. For the sake of explanation, the components illustrated in FIG. 7 and the various components included in the vehicle will be described with separate names and reference numbers.

Hereinafter, a method of autonomously driving a vehicle in an optimized manner or priding path information optimized for driving a vehicle will be described in more detail with reference to the accompanying drawings.

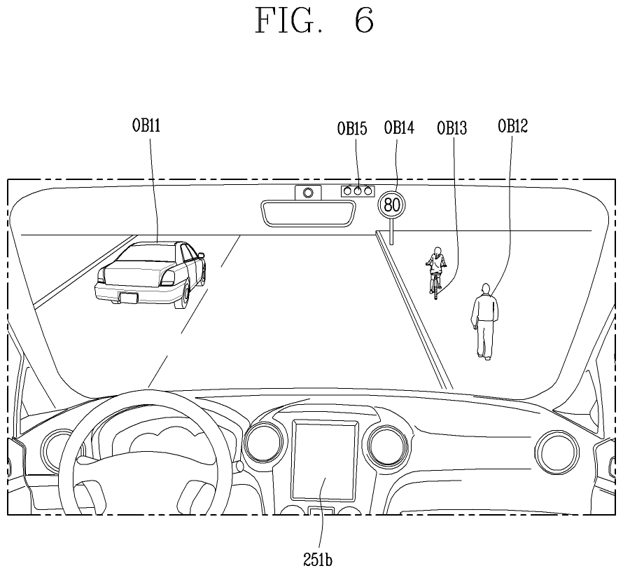

FIG. 8 is a conceptual view for explaining an electronic horizon provider (EHP).

Referring to FIG. 8, a path providing device 800 can control a vehicle 100 on the basis of eHorizon.

The path providing device 800 can be an EHP (Electronic Horizon Provider).

Here, Electronic Horizon can be referred to as “ADAS Horizon,” “ADASIS Horizon,” “Extended Driver Horizon” or “eHorizon.”

The eHorizon can be understood as software, a module or a system that performs the role of generating a vehicle's forward path information using high-definition (HD) map data, configuring it based on a specified standard (protocol) (e.g., a standard specification defined by the ADAS), and transmitting the configured data to an application (e.g., an ADAS application, a map application, etc.) installed in a module (for example, an ECU, a controller 170, a navigation system 770, etc.) of the vehicle or in the vehicle requiring map information (or path information).

In the past, the vehicle's forward path (or a path to the destination) has been provided as a single path based on a navigation map (or a path to the destination), but eHorizon can provide lane-based path information based on a high-definition (HD) map.

The data generated by eHorizon can be referred to as “electronic Horizon data” or “eHorizon data.”

The electronic horizon data can be described with driving plan data used when generating a driving control signal of the vehicle 100 in a driving system. For example, the electronic horizon data can be understood as driving plan data within a range from a point where the vehicle 100 is located to the horizon.

Here, the horizon can be understood as a point in front of a predetermined distance from a point where the vehicle 100 is located, on the basis of a preset driving path. The horizon can denote a point at which the vehicle 100 can reach after a preset period of time from a point where the vehicle 100 is located along a preset driving path. Here, the driving path denotes a driving path to the final destination, and can be set by a user input.

The electronic horizon data can include horizon map data and the horizon pass data. The horizon map data can include at least one of topology data, ADAS data, HD map data, and dynamic data. In some implementations, the horizon map data can include a plurality of layers. For example, the horizon map data can include a first layer matched with topology data, a second layer matched with ADAS data, a third layer matched with HD map data, and a fourth layer matched with dynamic data. The horizon map data can further include static object data.

The topology data can be described as a map created by connecting the center of the road. The topology data is suitable for roughly indicating the location of a vehicle, and can be in the form of data used primarily in navigation for a driver. The topology data can be understood as data on road information excluding information on lanes. The topology data can be generated based on data received at an infrastructure via V2I. The topology data can be based on data generated by the infrastructure. The topology data can be based on data stored in at least one memory provided in the vehicle 100.

The ADAS data can denote data related to road information. The ADAS data can include at least one of slope data of roads, curvature data of roads, and speed limit data of roads. The ADAS data can further include no overtaking section data. The ADAS data can be based on data generated by the infrastructure 20. The ADAS data can be based on data generated by the object detecting apparatus 300. The ADAS data can be referred to as road information data.

The HD map data can include topology information in a detailed lane unit of roads, connection information of each lane, feature information (e.g., traffic sign, lane marking/attribute, road furniture, etc.) for localization of a vehicle. The HD map data can be based on data generated by the infrastructure.

The dynamic data can include various dynamic information that can be generated on a road. For example, the dynamic data can include construction information, variable speed lane information, road surface state information, traffic information, moving object information, and the like. The dynamic data can be based on data received from the infrastructure 20. The dynamic data can be based on data generated by the object detecting apparatus 300.

The path providing device 800 can provide map data within a range from a point where the vehicle 100 is located to a horizon. The horizon pass data can be described as a trajectory that can be taken by the vehicle 100 within a range from a point where the vehicle 100 is located to a horizon. The horizon pass data can include data indicating a relative probability of selecting any one road at a decision point (e.g., a crossroad, a junction, an intersection, etc.). The relative probability can be calculated based on time taken to arrive at the final destination. For example, when the time taken to arrive at the final destination in case of selecting a first road is shorter than that in case of selecting a second road at a decision point, the probability of selecting the first road can be calculated higher than that of selecting the second road.

The horizon pass data can include a main path and a sub path. The main path can be understood as a trajectory connecting roads with a relatively high probability of being selected. The sub path can be branched from at least one decision point on the main path. The sub path can be understood as a trajectory connecting at least any one road having a low relative probability of being selected on at least one decision point on the main path.

eHorizon can be classified into categories such as software, a system, a concept, and the like. The eHorizon denotes a configuration in which road shape information on a high-definition map under a connected environment such as an external server (e.g., cloud server), V2X (vehicle to everything) or the like and real-time events such as real-time traffic signs, road surface conditions, accidents and the like are merged to provide relevant information to autonomous driving systems and infotainment systems.

In other words, eHorizon can perform the role of transferring a precision map road shape and real time events in front of the vehicle to autonomous driving systems and infotainment systems under an external server/V2X environment.

In order to effectively transfer eHorizon data (information) transmitted (generated) from the eHorizon to autonomous driving systems and infotainment systems, a data specification and transmission method can be formed in accordance with a standard called “ADASIS (Advanced Driver Assistance Systems Interface Specification).”

The vehicle control device can use information received (generated) from eHorizon for autonomous driving systems and/or infotainment systems.

For example, autonomous navigation systems can use information provided by eHorizon in the safety and ECO aspects.

In terms of the safety aspect, the vehicle 100 can perform an ADAS (Advanced Driver Assistance System) function such as LKA (Lane Keeping Assist), TJA (Traffic Jam Assist) or the like, and/or an AD (AutoDrive) function such as advance, road joining, lane change or the like using road shape information and event information received from eHorizon and surrounding object information sensed through the sensing unit 840 provided in the vehicle.

Furthermore, in terms of the ECO aspect, the path providing device 800 can receive inclination information, traffic light information, and the like on a front road from eHorizon to control the vehicle so as to achieve efficient engine output, thereby enhancing fuel efficiency.

The infotainment system can include convenience aspects.

For example, the vehicle 100 can receive accident information, road surface condition information, and the like on a front road received from eHorizon to output them on a display unit (for example, HUD (Head Up Display), CID, Cluster, etc.) provided in the vehicle to provide guide information for allowing the driver to perform safe driving.

The eHorizon can receive the location information of various event information (e.g., road surface condition information, construction information, accident information, etc.) generated from a road and/or road specific speed limit information from the present vehicle 100 or other vehicles or collect them from an infrastructure (e.g., a measuring device, a sensing device, a camera, etc.) installed on a road.

Furthermore, the event information and the road specific speed limit information can be linked to map information or can be updated.

In addition, the location information of the event information can be divided into units of lanes.

Using the information, the eHorizon (or EHP) of the present disclosure can provide information required for autonomous driving system and infotainment systems to each vehicle based on a precision map capable of determining a road situation (or road information) in units of lanes.

In other words, the eHorizon provider (EHP) of the present disclosure can provide an absolute high-definition map using an absolute coordinate of information (for example, event information, location information of the present vehicle 100, etc.) associated with a road based on a high-definition map.

The information associated with a road provided by the eHorizon can be provided with information provided within a predetermined region (predetermined space) with respect to the present vehicle 100.

The EHP (Electronic Horizon Provider) can be understood as a component included in the eHorizon system to perform a function provided by the eHorizon (or eHorizon system).

The path providing device 800 of the present disclosure can be an EHP, as illustrated in FIG. 8.

The path providing device 800 (EHP) of the present disclosure can receive a high-definition map from an external server (or cloud server), generate path information to a destination in units of lanes, and transmit the high-definition map and the path information generated in units of lanes to a module or application (or program) of a vehicle that needs the map information and path information.

Referring to FIG. 8, the overall structure of the electronic horizon system of the present disclosure is illustrated in FIG. 8.

The path providing device 800 (EHP) of the present disclosure can include a telecommunication control unit (TCU) 810 for receiving a high-definition (HD) map existing in a cloud server.

The telecommunication control unit 810 can be a communication apparatus 400 described above, and can include at least one of components included in the communication apparatus 400.

The telecommunication control unit 810 can include a telematics module or a V2X (vehicle to everything) module.

The telecommunication control unit 810 can receive a high-definition (HD) map according to the Navigation Data Standard (NDS) (or conforming to the NDS standard) from a cloud server.

In addition, the high-definition (HD) map can be updated by reflecting data sensed through a sensor provided in a vehicle and/or a sensor installed on an adjacent road according to a sensor ingestion interface specification (SENSORIS) which is a sensor ingestion interface specification.

The telecommunication control unit 810 can download a HD-map from a cloud server through the telematics module or the V2X module.

The path providing device 800 of the present disclosure can include an interface unit 820. The interface unit 820 receives sensing information from one or more sensors provided in the vehicle 100.

The interface unit 820 can be referred to as a sensor data collector.

The interface unit 820 can collect (receive) information sensed through sensors (for example, sensors (V. sensors) (e.g., heading, throttle, break, wheel, etc.) for sensing the operation of a vehicle) and sensors (S. sensors) (e.g., camera, radar, LiDAR, sonar, etc.) for sensing the surrounding information of a vehicle).

The interface unit 820 can transmit the information sensed through the sensors provided in a vehicle to the telecommunication control unit 810 (or the processor 830) to reflect the information on the high-definition map. For example, the interface unit 820 can include at least one of an electric circuit, a processor, a communication device, a signal receiver, a signal transmitter, transceiver, or the like. In some examples, the interface unit 820 can be a software module including one or more computer programs or instructions. In some cases, the interface unit 820 can be a part of the processor 830.

The telecommunication control unit 810 can update the high-definition map stored in the cloud server by transmitting the information transmitted from the interface unit 820 to the cloud server.

The path providing device 800 of the present disclosure can include a processor 830 (or an eHorizon module).

The processor 830 can control the telecommunication control unit 810 and the interface unit 820.

The processor 830 can store a high-definition map received through the telecommunication control unit 810, and update the high-definition map using information received through the interface unit 820. Such an operation can be carried out in the storage unit 832 of the processor 830.

The processor 830 can receive first path information from an AVN (Audio Video Navigation) or a navigation system 770.

The first path information, as path information provided in the related art, can be information for guiding a driving path to a destination.

At this time, the first path information provided in the related art provides only one path information, and does not distinguish lanes.

On the other hand, when the processor 830 receives the first path information, the processor 830 can generate second path information for guiding a driving path to a destination set in the first path information in units of lanes using a high-definition (HD) map and the first path information. Such an operation can be carried out in the operation unit 834 of the processor 830.

In some implementations, the eHorizon system can include a sensing unit 840 (or localization unit) for locating a vehicle using information sensed through sensors (V. sensors, S.sensors) provided in the vehicle.

The sensing unit 840 can transmit the location information of the vehicle to the processor 830 so as to match the location of the vehicle detected using the sensors provided in the vehicle to the high-definition map.

The processor 830 can match the location of the vehicle 100 to the high-definition map based on the location information of the vehicle.

The processor 830 can generate electronic horizon data. The processor 830 can generate electronic horizon data. The processor 830 can generate horizon pass data.

The processor 830 can generate the electronic horizon data by reflecting the driving environment of the vehicle 100. For example, the processor 830 can generate the electronic horizon data based on the driving direction data and the driving speed data of the vehicle 100.

The processor 830 can merge the generated electronic horizon data with previously generated electronic horizon data. For example, the processor 830 can connect horizon map data generated at a first time point with horizon map data generated at a second time point. For example, the processor 830 can connect horizon pass data generated at a first time point with horizon pass data generated at a second time point.

The processor 830 can include a memory, an HD map processing unit, a dynamic data processing unit, a matching unit, and a path generation unit. For example, the memory can be a non-transitory memory device.

The HD map processing unit can receive HD map data from a server via the communication device. The HD map processing unit can store the HD map data. In some implementations, the HD map processing unit can process and fabricate the HD map data. The dynamic data processing unit can receive dynamic data from the object detecting apparatus. The dynamic data processing unit can receive dynamic data from the server. The dynamic data processing unit can store dynamic data. In some implementations, the dynamic data processing unit 172 can process and refine the dynamic data.

The matching unit can receive a HD map from the HD map processing unit 171. The matching unit can receive dynamic data from the dynamic data processing unit. The matching unit can generate horizon map data by matching the HD map data and the dynamic data.

In some implementations, the matching unit can receive topology data. The matching unit can ADAS data. The matching unit can generate horizon map data by matching the topology data, the ADAS data, the HD map data, and the dynamic data. The path generation unit can generate horizon pass data. The path generation unit can include a main path generation unit and a sub path generation unit. The main path generation unit can generate main pass data. The sub path generation unit can generate sub pass data.

Furthermore, the eHorizon system can include a merge unit 850 that merges information (data) sensed by sensors provided in the vehicle with eHorizon data formed by the eHorizon module (controller). For example, the merge unit 850 can include at least one of an electric circuit, a processor, a communication device, a signal receiver, a signal transmitter, transceiver, or the like. In some examples, the merge unit can be a software module including one or more computer programs or instructions. In some cases, the merge unit 850 can be a part of the processor 830. The merge unit 850 may merge the date by combining the sensed information and the eHorizon data into another data set.

For example, the merge unit 850 can update a high-definition map by merging sensor data sensed in the vehicle to a high-definition map corresponding to eHorizon data, and provide the updated high-definition map to an ADAS function, an AD (AutoDrive) function, or an ECO function.

In some examples, the merge unit 850 can also provide the updated high-definition map to the infotainment system.

In FIG. 8, it is illustrated that the path providing device 800 (EHP) of the present disclosure includes only the telecommunication control unit 810, the interface unit 820, and the processor 830, but the present disclosure is not limited thereto.

The path providing device 800 of the present disclosure can further include at least one of a sensing unit 840 and a merge unit 850.

In addition, the path providing device 800 (EHP) of the present disclosure can further include a navigation system 770.

Through the above arrangement, when at least one of the sensing unit 840, the merge unit 850, and the navigation system 770 is included in the path providing device 800 (EHP) of the present disclosure, it can be understood that the function/operation/control carried out by the component included therein is carried out by the processor 830.

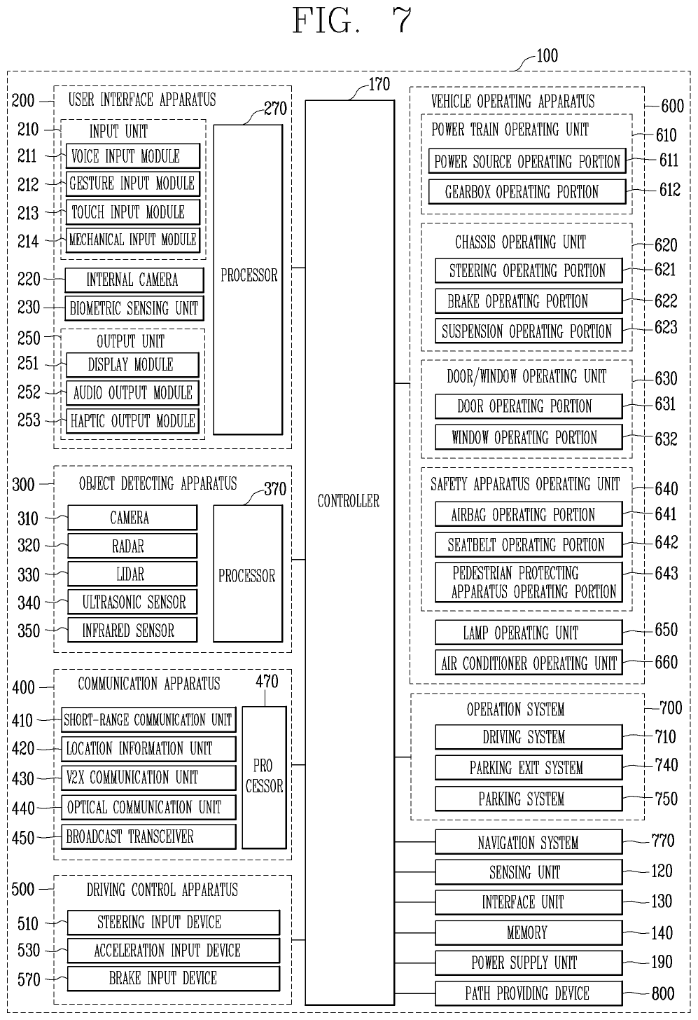

FIG. 9 is a block diagram for explaining the path providing device of FIG. 8 in more detail.

The path providing device denotes a device for providing a path to a vehicle.

For example, the path providing device can be a device mounted on a vehicle to perform communication via CAN communication, and generate a message for controlling a vehicle and/or an electrical part mounted on the vehicle.

As another example, the path providing device can be located outside the vehicle, such as a server or a communication device, to communicate with the vehicle through a mobile communication network. In this case, the path providing device can remotely control the vehicle and/or the electrical part mounted on the vehicle using the mobile communication network.

The path providing device 800 is provided in the vehicle, and can be configured with an independent device that is attachable and detachable from the vehicle, or can be a component of the vehicle installed integrally with the vehicle.

Referring to FIG. 9, the path providing device 800 includes a telecommunication control unit 810, an interface unit 820, and a processor 830.

The telecommunication control unit 810 is configured to perform communication with various components provided in the vehicle.

For example, the telecommunication control unit 810 can receive various information provided through a controller area network (CAN).

The telecommunication control unit 810 includes a first telecommunication control unit 812 that can receive a high-definition map provided through telematics. In other words, the first telecommunication control unit 812 performs ‘telematics communication’. The telematics communication can perform communication with a server or the like using a satellite navigation system satellite or a base station provided by mobile communication such as 4G and 5G. For instance, the first telecommunication control unit 812 can include an electric circuit, a processor, a controller, a transceiver, or the like.

The first telecommunication control unit 812 can perform communication with a telematics communication device 910. The telematics communication device can include a server provided by a portal provider, a vehicle provider, and/or a mobile communication company.

The processor 830 of the path providing device 800 of the present disclosure can determine the absolute coordinates of information (event information) related to a road based on the ADAS MAP received from an external server (eHorizon) through the eHorizon module. In addition, the processor 830 can perform autonomous driving or vehicle control on the present vehicle using the absolute coordinates of information (event information) related to the road. For instance, the processor 830 can include an electric circuit, an integrated circuit, or the like.

The telecommunication control unit 810 includes a second telecommunication control unit 814, and the second telecommunication control unit 814 can receive various information provided through V2X (Vehicle to everything). In other words, the second telecommunication control unit 814 is configured to perform ‘V2X communication’. V2X communication can be defined as a technology that exchanges information such as traffic situation while communicating with road infrastructure and other vehicles while driving.

The second telecommunication control unit 814 can perform communication with a V2X communication device 930. The V2X communication device can include a mobile terminal possessed by a pedestrian or a bicycle rider, a stationary terminal installed on a road, another vehicle, and the like. For instance, the second telecommunication control unit 814 can include an electric circuit, a processor, a controller, a transceiver, or the like.

Here, the another vehicle can denote at least one of vehicles existing within a predetermined distance with respect to the present vehicle 100 or vehicles entering a predetermined distance with respect to the present vehicle 100.

The present disclosure may not be necessarily limited thereto, and the another vehicle can include all vehicles capable of communicating with the telecommunication control unit 810. In the present specification, for the sake of convenience of explanation, a case where the nearby vehicle exists within a predetermined distance from the present vehicle 100 or enters within the predetermined distance will be described as an example.

The predetermined distance can be determined based on a communicable distance through the telecommunication control unit 810, determined according to the specification of a product, or can be determined or varied based on a user's setting or the standard of V2X communication.

The second telecommunication control unit 814 can be formed to receive LDM data from another vehicle. The LDM data can be a V2X message (BSM, CAM, DENM, etc.) transmitted and received between vehicles through V2X communication.

The LDM data can include the location information of another vehicle.

Based on the location information of the present vehicle and the location information of another vehicle included in LDM data received through the second telecommunication control unit 814, the processor 830 can determine a relative location between the present vehicle and another vehicle.

Furthermore, the LDM data can include the speed information of another vehicle. The processor 830 can also determine a relative speed of another vehicle using the speed information of the present vehicle and the speed information of the another vehicle. The speed information of the present vehicle can be calculated using a degree to which the location information of the vehicle changes over time or calculated based on information received from the driving control apparatus 500 or the power train operating unit 610 of the vehicle 100.

The second telecommunication control unit 814 can be the V2X communication unit 430 described above.

If the telecommunication control unit 810 is a component that communicates with a device located outside the vehicle 100 using wireless communication, the interface unit 820 is a component that communicates with a device located inside the vehicle 100 using wired or wireless communication.

The interface unit 820 can receive information related to the driving of the vehicle from most of the electrical parts provided in the vehicle. Information transmitted from an electrical part provided in the vehicle 100 to the path providing device 800 is referred to as ‘vehicle driving information.’

For example, when the electrical part is a sensor, the vehicle driving information can be sensing information sensed by the sensor.

The vehicle driving information includes vehicle information and surrounding information of the vehicle. The information related to an inside of the vehicle with respect to the frame of the vehicle 100 can be defined as vehicle information, and the information related to an outside of the vehicle can be defined as surrounding information.

Vehicle information denotes information on the vehicle itself. For example, the vehicle information can include at least one of a driving speed of the vehicle, a driving direction, an acceleration, an angular speed, a position (GPS), a weight, a number of vehicle occupants, a braking force of the vehicle, a maximum braking force of the vehicle, an air pressure of each wheel, a centrifugal force applied to the vehicle, a driving mode of the vehicle (whether it is an autonomous driving mode or a manual driving mode), a parking mode of the vehicle (autonomous parking mode, automatic parking mode, manual parking mode), whether or not a user is on board the vehicle, information related to the user, and the like.

The surrounding information denotes information relate to another object located within a predetermined range around the vehicle and information related to the outside of the vehicle. The surrounding information of the vehicle can be a state of road surface (frictional force) on which the vehicle is traveling, weather, a distance from a front-side (rear-side) vehicle, a relative speed of a front-side (rear-side) vehicle, a curvature of curve when a driving lane is the curve, an ambient brightness of the vehicle, information associated with an object existing in a reference region (predetermined region) based on the vehicle, whether or not an object enters (or leaves) the predetermined region, whether or not a user exists around the vehicle, and information associated with the user (for example, whether or not the user is an authenticated user), and the like.

In addition, the surrounding information can include an ambient brightness, a temperature, a sun position, surrounding object information (a person, a vehicle, a sign, etc.), a type of road surface during driving, a geographic feature, line information, driving lane Information, and information required for autonomous driving/autonomous parking/automatic parking/manual parking mode.

Furthermore, the surrounding information can further include a distance from an object existing around the vehicle to the vehicle, a possibility of collision, a type of the object, a parking space for the vehicle, an object for identifying the parking space (e.g., a parking line, a string, another vehicle, a wall, etc.), and the like.

The vehicle driving information is not limited to the example described above and can include all information generated from the components provided in the vehicle.

In some implementations, the processor 830 is configured to control one or more devices provided in the vehicle using the interface unit 820.

Specifically, the processor 830 can determine whether at least one of a plurality of preset conditions is satisfied based on vehicle driving information received through the telecommunication control unit 810. Depending on the satisfied conditions, the processor 830 can control the one or more electrical parts in different ways.

In connection with the preset condition, the processor 830 can sense the occurrence of an event in an electronic unit and/or application provided in the vehicle and determine whether the sensed event satisfies the preset condition. At this time, the processor 830 can detect the occurrence of an event from information received through the telecommunication control unit 810.

The application is a concept including a widget, a home launcher, and the like, and refers to all types of programs that can be driven on the vehicle. Accordingly, the application can be a program that performs a function of web browser, video playback, message transmission/reception, schedule management, and application update.

In addition, the application can include forward collision warning (FCW), blind spot detection (BSD), lane departure warning (LDW), pedestrian detection (PD), curve speed warning (CSW), and turn-by-turn navigation (TBT).

For example, an event can occur when there is a missed call, when there is an application to be updated, when a message arrives, start on, start off, autonomous driving on/off, LCD awake key, alarm, incoming call, missed notification, or the like.

As another example, an event can occur when a warning set by an advanced driver assistance system (ADAS) occurs or a function set by the ADAS is performed. For example, when a forward collision warning occurs, when a blind spot detection occurs, when a lane departure warning occurs, when a lane keeping assist warning occurs, when autonomous emergency braking function is performed, or the like can be seen as an occurrence of an event.

In some examples, when changed from a forward gear to a reverse gear, when an acceleration greater than a predetermined value is generated, when a deceleration greater than a predetermined value is generated, when a power device is changed from an internal combustion engine to a motor, when changed from the motor to the internal combustion engine, or the like can also be seen as an occurrence of an event.

In addition, when various ECUs provided in the vehicle perform a specific function can also be seen as an occurrence of an event.

For example, when the occurred event satisfies a preset condition, the processor 830 can control the interface unit 820 to display information corresponding to the satisfied condition on the one or more displays.

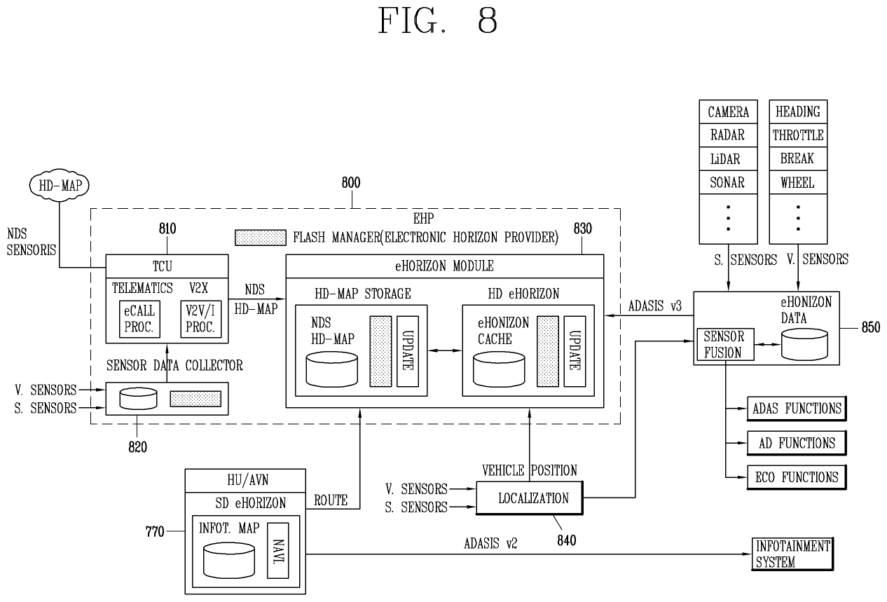

FIG. 10 is a conceptual view for explaining eHorizon.

Referring to FIG. 10, the path providing device 800 can allow a vehicle 100 to autonomously drive on the basis of eHorizon.

eHorizon can be classified into categories such as software, a system, a concept, and the like. eHorizon denotes a configuration in which road shape information on a precision map under a connected environment such as an external server (cloud), V2X (vehicle to everything) or the like and real-time events such as real-time traffic signs, road surface conditions, accidents and the like are merged to provide relevant information to autonomous driving systems and infotainment systems.

For example, eHorizon can refer to an external server (or cloud, cloud server).

In other words, eHorizon can perform the role of transferring a precision map road shape and real time events in front of the vehicle to autonomous driving systems and infotainment systems under an external server/V2X environment.

In order to effectively transfer eHorizon data (information) transmitted from the eHorizon (i.e., external server) to autonomous driving systems and infotainment systems, a data specification and transmission method can be formed in accordance with a standard called “ADASIS (Advanced Driver Assistance Systems Interface Specification).”

The path providing device 800 can use information received from eHorizon for autonomous driving systems and/or infotainment systems.

For example, autonomous navigation systems can be divided into safety aspects and ECO aspects.

In terms of the safety aspect, the path providing device 800 can perform an ADAS (Advanced Driver Assistance System) function such as LKA (Lane Keeping Assist), TJA (Traffic Jam Assist) or the like, and/or an AD (AutoDrive) function such as advance, road joining, lane change or the like using road shape information and event information received from eHorizon and surrounding object information sensed through the sensing unit 840 provided in the vehicle.

Furthermore, in terms of the ECO aspect, the path providing device 800 can receive inclination information, traffic light information, and the like on a front road from eHorizon to control the vehicle so as to achieve efficient engine output, thereby enhancing fuel efficiency.

The infotainment system can include convenience aspects.

For example, the path providing device 800 can receive accident information, road surface condition information, and the like on a front road received from eHorizon to output them on a display unit (for example, HUD (Head Up Display), CID, Cluster, etc.) provided in the vehicle to provide guide information for allowing the driver to perform safe driving.

Referring to FIG. 10, the eHorizon (external server) can receive the location information of various event information (e.g., road surface condition information 1010a, construction information 1010b, accident information 1010c, etc.) generated from a road and/or road specific speed limit information 1010d from the present vehicle 100 or other vehicles 1020a, 1020b or collect them from an infrastructure (e.g., a measuring device, a sensing device, a camera, etc.) installed on a road.

Furthermore, the event information and the road specific speed limit information can be linked to map information or can be updated.

In addition, the location information of the event information can be divided into units of lanes.

Using the information, the eHorizon (external server) of the present disclosure can provide information required for autonomous driving system and infotainment systems to each vehicle based on a precision map capable of determining a road situation (or road information) in units of lanes.

In other words, the eHorizon (external server) of the present disclosure can provide an absolute high-definition map using an absolute coordinate of information (for example, event information, location information of the present vehicle 100, etc.) associated with a road based on a precision map.

The information associated with a road provided by the eHorizon can be provided only within a predetermined region (predetermined space) with respect to the present vehicle 100.

On the other hand, the path providing device 800 of the present disclosure can acquire location information of another vehicle through communication with the another vehicle. Communication with another vehicle can be carried out through V2X (vehicle to everything) communication, and data transmitted and received to and from another vehicle through V2X communication can be data in a format defined by the LDM (Local Dynamic Map) standard.

The LDM denotes a conceptual data storage located in a vehicle control unit (or ITS station) including information related to a safe and normal operation of an application (or application program) provided in a vehicle (or an intelligent transport system (ITS)). The LDM may, for example, comply with EN standards.

The LDM differs from the ADAS MAP described above in the data format and transmission method. For example, the ADAS MAP corresponds to a high-definition map having absolute coordinates received from eHorizon (external server), and the LDM can denote a high-definition map having relative coordinates based on data transmitted and received through V2X communication.

The LDM data (or LDM information) is data that is mutually transmitted and received in V2X communication (vehicle to everything) (for example, V2V (vehicle to vehicle) communication, V2I (vehicle to infrastructure) communication, V2P (vehicle to pedestrian) communication.

The LDM is a concept of a storage for storing data transmitted and received in V2X communication, and the LDM can be formed (stored) in a vehicle control device provided in each vehicle.

The LDM data can denote, for example, data that is mutually transmitted and received between a vehicle and a vehicle (infrastructure, pedestrian) or the like. The LDM data can include, for example, a Basic Safety Message (BSM), a Cooperative Awareness Message (CAM), a Decentralized Environmental Notification Message (DENM), and the like.

The LDM data can be referred to as, for example, a V2X message or an LDM message.

The vehicle control device related to the present disclosure can efficiently manage LDM data (or V2X message) transmitted and received between vehicles efficiently using an LDM.

Based on LDM data received through V2X communication, the LDM can store all relevant information (e.g., the present vehicle (another vehicle) location, speed, traffic light status, weather information, road surface condition, etc.) on a traffic condition (or a road condition for an area within a predetermined distance from a place where a vehicle is currently located) around a place where a vehicle is currently located, and distribute them to other vehicles and continuously update them.

For example, a V2X application provided in the path providing device 800 registers with the LDM, and receives specific messages such as all DENMs including a warning about a faulty vehicle. Then, the LDM automatically allocates the received information to the V2X application, and the V2X application can control the vehicle based on information allocated from the LDM.

In this manner, the vehicle of the present disclosure can control the vehicle using an LDM formed by LDM data collected through V2X communication.

The LDM can provide information related to a road to the vehicle control device. The information related to a road provided by the LDM provides only relative distances and relative speeds between other vehicles (or generated event points), other than map information with absolute coordinates.

In other words, the vehicle of the present disclosure can construct autonomous driving using an ADAS MAP (absolute coordinate high-definition map) according to the ADASIS standard provided by eHorizon, but the ADAS MAP can be used only to determine a road condition in a surrounding area of the present vehicle (an own vehicle).

In addition, the vehicle of the present disclosure can construct autonomous driving using an LDM (relative coordinate high-definition map) formed by LDM data received through V2X communication, but there is a limit in that accuracy is inferior due to insufficient absolute location information.

The vehicle control device included in the vehicle of the present disclosure can generate a merged precision map using the LDM data received through the VAS communication with the ADAS MAP received from eHorizon and, control the vehicle in an optimized manner using the merged precision map (autonomous driving).

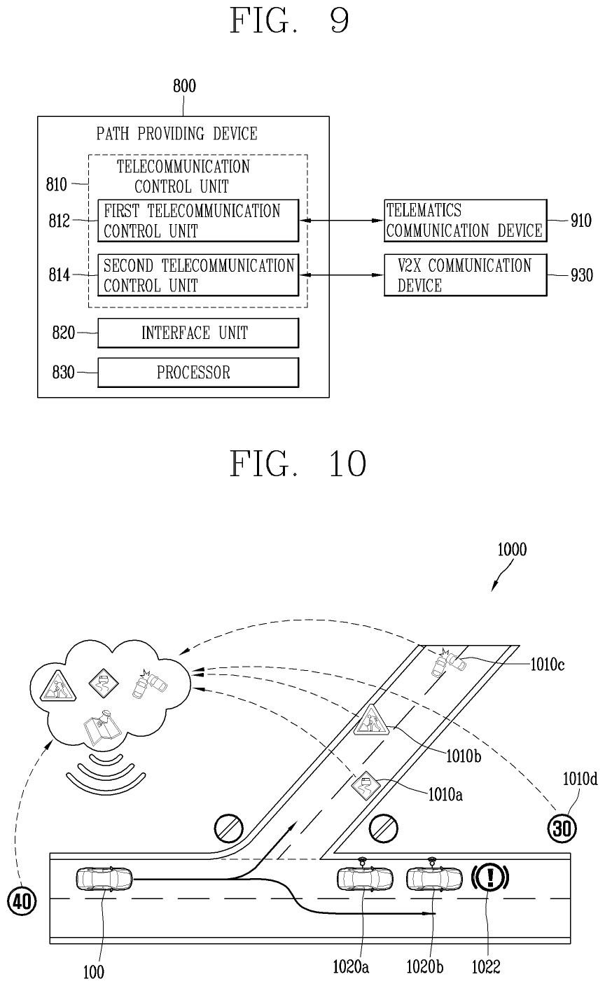

An example of a data format of the LDM data (or LDM) transmitted and received between vehicles through V2X communication is illustrated in FIG. 11A, and an example of a data format of the ADAS MAP received from an external server (eHorizon) is illustrated in FIG. 11B.

Referring to FIG. 11A, the LDM data (or LDM) 1050 can be formed to have four layers. The LDM data 1050 can include a first layer 1052, a second layer 1054, a third layer 1056, and a fourth layer 1058.

The first layer 1052 can include static information, for example, map information, among information related to a road.

The second layer 1054 can include landmark information (e.g., specific place information specified by a maker among a plurality of place information included in the map information) among information related to the road. The landmark information can include location information, name information, size information, and the like.

The third layer 1056 can include information (e.g., traffic light information, construction information, accident information, etc.) among information related to the road. The construction information, the accident information and the like can include location information.

The fourth layer 1058 can include dynamic information (e.g., object information, pedestrian information, other vehicle information, etc.) among information related to the road. The object information, pedestrian information, and other vehicle information can include location information.

In other words, the LDM data 1050 can include information sensed through the sensing unit of another vehicle or information sensed through the sensing unit of the present vehicle, and can include information related to a road that is modified in real time as it goes from a first layer to a fourth layer.

Referring to FIG. 11B, the ADAS MAP can be formed to have four layers similar to the LDM data.

The ADAS MAP 1060 can denote data received from eHorizon and formed to conform to the ADASIS standard.

The ADAS MAP 1060 can include a first layer 1062 to a fourth layer 1068.

The first layer 1062 can include topology information. The topology information, as information that explicitly defines a spatial relationship, for example, and can refer to map information.

The second layer 1064 can include landmark information (e.g., specific place information specified by a maker among a plurality of place information included in the map information) among information related to the road. The landmark information can include location information, name information, size information, and the like.

The third layer 1066 can include high-definition map information. The high-definition map information can be referred to as an HD-MAP, and information related to the road (e.g., traffic light information, construction information, accident information) can be recorded in units of lanes. The construction information, the accident information and the like can include location information.

The fourth layer 1068 can include dynamic information (e.g., object information, pedestrian information, other vehicle information, etc.). The object information, pedestrian information, and other vehicle information can include location information.

In other words, the ADAS MAP 1060 can include information related to a road that is modified in real time as it goes from the first layer to the fourth layer, such as the LDM data 1050.

The processor 830 can autonomously drive the vehicle 100.

For example, the processor 830 can autonomously drive the vehicle 100 based on vehicle driving information sensed from various electrical parts provided in the vehicle 100 and information received through the telecommunication control unit 810.

Specifically, the processor 830 can control the telecommunication control unit 810 to acquire the location information of the vehicle. For example, the processor 830 can acquire the location information (location coordinates) of the present vehicle 100 through the location information unit 420 of the telecommunication control unit 810.

Furthermore, the processor 830 can control the first telecommunication control unit 812 of the telecommunication control unit 810 to receive map information from an external server. Here, the first telecommunication control unit 812 can receive an ADAS MAP from the external server (eHorizon). The map information can be included in the ADAS MAP.

Furthermore, the processor 830 can control the second telecommunication control unit 814 of the telecommunication control unit 810 to receive the location information of another vehicle from the another vehicle. Here, the second telecommunication control unit 814 can receive LDM data from another vehicle. The location information of the another vehicle can be included in the LDM data.

The another vehicle denotes a vehicle existing within a predetermined distance from the vehicle, and the predetermined distance can be a communication available distance of the telecommunication control unit 810 or a distance set by a user.

The processor 830 can control the communication unit to receive map information from an external server and the location information of another vehicle from the another vehicle.

In addition, the processor 830 can merge the acquired location information of the vehicle and the received location information of the another vehicle into the received map information, and control the vehicle 100 based on at least one of the merged map information and information related to the vehicle sensed through the sensing unit 840.

Here, map information received from the external server can denote high-definition map information (HD-MAP) included in an ADAS MAP. The high-definition map information can record information related to the road in units of lanes.

The processor 830 can merge the location information of the present vehicle 100 and the location information of another vehicle into the map information in units of lanes. In addition, the processor 830 can merge information related to the road received from an external server and information related to the road received from another vehicle into the map information in units of lanes.

The processor 830 can generate an ADAS MAP necessary for the control of the vehicle using the ADAS MAP received from the external server and information related to the vehicle received through the sensing unit 840.

Specifically, the processor 830 can apply information related to the vehicle sensed within a predetermined range through the sensing unit 840 to map information received from the external server.

Here, the predetermined range can be an available distance from which an electrical part provided in the present vehicle 100 senses information, or can be a distance set by a user.

The processor 830 can apply the information related to the vehicle sensed within a predetermined range through the sensing unit to the map information and then additionally merge the location information of another vehicle therewith to control the vehicle.

In other words, when the information related to the vehicle sensed within a predetermined range through the sensing unit is applied to the map information, the processor 830 can use only the information within the predetermined range from the vehicle, and thus a range capable of controlling the vehicle can be geographically narrow.

However, the location information of another vehicle received through the V2X module can be received from the another vehicle existing in a space out of the predetermined range. It is because a communication available distance of the V2X module communicating with other vehicles through the V2X module is farther than a predetermined range of the sensing unit 840.

As a result, the processor 830 can merge the location information of other vehicles included in LDM data received through the second telecommunication control unit 814 with map information on which information related to the vehicle is sensed to acquire the location information of other vehicles existing in a wider range, and more effectively control the vehicle using the merged information.

For example, it is assumed that a plurality of other vehicles are densely packed forward in a lane in which the present vehicle exists, and also assumed that the sensing unit can sense only the location information of a vehicle right in front of the present vehicle.

In this case, when only information related to the vehicle sensed within a predetermined range is used in the map information, the processor 830 can generate a control command for controlling the vehicle to allow the present vehicle to pass and overtake a vehicle in front.

However, in reality, there can be a situation in which a plurality of other vehicles are densely packed forward, and it is not easy to pass and overtake.

At this time, the present disclosure can acquire the location information of other vehicles received through the V2X module. At this time, the received location information of the other vehicles can acquire the location information of not only a vehicle right in front of the present vehicle 100 but also a plurality of other vehicles in front of the front vehicle.

The processor 830 can additionally merge the location information of a plurality of vehicles acquired through the V2X module with map information to which information related to the vehicle is applied to determine whether it is an inadequate situation to pass and overtake a vehicle in front.

Through the foregoing configuration, the present disclosure can may merge only information related to the vehicle acquired through the sensing unit 840 into high-definition map information to overcome the technical limitations of the related art that allows autonomous driving only in a predetermined range. In other words, the present disclosure can use not only information related to another vehicle received from the another vehicle at a distance greater than the predetermined range through the V2X module but also information related to the vehicle sensed through the sensing unit, thereby performing vehicle control in a more accurate and stable manner.

The vehicle control described in the present specification can include at least one of autonomously driving the vehicle 100 and outputting a warning message related to driving of the vehicle.

Hereinafter, a method of allowing the processor to control a vehicle using LDM data received through the V2X module, an ADAS MAP received from an external server (eHorizon), and information related to the vehicle sensed through the sensing unit provided in the vehicle will be described in more detail with reference to the accompanying drawings.

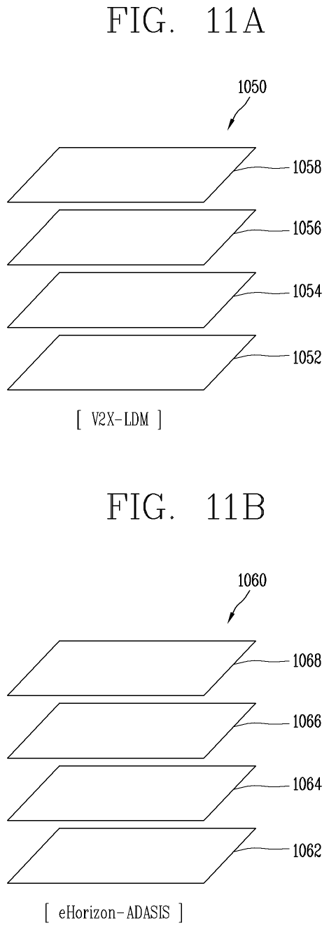

FIGS. 12A and 12B are exemplary views illustrating a method of receiving a high-definition map data by a communication device.

The server can divide HD map data into tile units and provide them to the path providing device 800. The processor 830 can receive HD map data in units of tiles from a server or another vehicle through the telecommunication control unit 810. The HD map data received in units of tiles is referred to as ‘HD map tiles’ below.

The HD map data is partitioned into tiles having a predetermined shape, and each tile corresponds to a different part of the map. When all the tiles are connected, entire HD map data is acquired. Since the HD map data has a high capacity, a high-capacity memory is required for the vehicle 100 to download and use the entire HD map data. It is more efficient to download, use and delete HD map data in units of tiles rather than providing a high-capacity memory in the vehicle 100 with the development of communication technology.

In the present disclosure, for convenience of explanation, a case where the predetermined shape is a rectangle will be described as an example, but it can be modified into various polygonal shapes.

The processor 830 can store the downloaded HD map tiles in the memory 140. The processor 830 can delete the stored HD map tiles. For example, the processor 830 can delete the HD map tiles when the vehicle 100 leaves a region corresponding to the HD map tiles. For example, the processor 830 can delete the HD map tiles after a preset period of time elapses subsequent to storing the HD map tiles.

As illustrated in FIG. 12A, when there is no preset destination, the processor 830 can receive a first HD map tile 1251 including the location 1250 of the vehicle 100. A server 21 can receive the location 1250 data of the vehicle 100 from the vehicle 100, and provide the first HD map tile 1251 including the location 1250 of the vehicle 100 to the vehicle 100. Furthermore, the processor 830 can receive HD map tiles 1252, 1253, 1254, 1255 around the first HD map tile 1251. For example, the processor 830 can receive the HD map tiles 1252, 1253, 1254, 1255 adjacent to the top, bottom, left, and right of the first HD map tile 1251, respectively. In this case, the processor 830 can receive a total of five HD map tiles. For example, the processor 830 can further receive a HD map tile located in a diagonal direction, along with the HD map tiles 1252, 1253, 1254, 1255 adjacent to the top, bottom, right, and left of the first HD map tile 1251, respectively. In this case, the processor 830 can receive a total of nine HD map tiles.

As illustrated in FIG. 12B, when there is a preset destination, the processor 830 can receive a tile associated with a path from the location 1250 of the vehicle 100 to the destination. The processor 830 can receive a plurality of tiles to cover the path.

The processor 830 can receive the entire tiles covering the path at once.

Alternatively, the processor 830 can divide and receive the entire tiles while the vehicle 100 is moving along the path. The processor 830 can receive at least part of the entire tiles based on the location of the vehicle 100 while the vehicle 100 is moving along the path. Then, the processor 830 can continuously receive tiles and delete the received tiles while the vehicle 100 is moving.

The processor 830 can generate electronic horizon data based on HD map data.

The vehicle 100 can be driven with the final destination being set. The final destination can be set based on a user input received through the user interface apparatus 200 or the communication apparatus 400. Depending on the implementation, the final destination can be set by the driving system 260.

With the final destination being set, the vehicle 100 can be located within a preset distance a first point while driving. When the vehicle 100 is located within a preset distance from the first point, the processor 830 can generate electronic horizon data having the first point as a starting point and the second point as an end point. The first point and the second point can be one point on a path to the final destination. The first point can be described as a point at which the vehicle 100 is located or to be located in the near future. The second point can be described by the horizon mentioned above.

The processor 830 can receive a HD map in an area including a section from the first point to the second point. For example, the processor 830 can request and receive a HD map for an area within a predetermined radius from the section from the first point to the second point.

The processor 830 can generate electronic horizon data for an area including the section from the first point to the second point based on the HD map. The processor 830 can generate horizon map data for an area including the section from the first point to the second point. The processor 830 can generate horizon pass data for an area including the section from the first point to the second point. The processor 830 can generate main pass 313 data for an area including the section from the first point to the second point. The processor 830 can generate sub pass 314 data for an area including the section from the first point to the second point.

When the vehicle 100 is located within a preset distance from the first point, the processor 830 can generate electronic horizon data having the second point as a starting point and a third point as an end point. The second point and the third point can be one point on a path to the final destination. The second point can be described as a point at which the vehicle 100 is located or to be located in the near future. The third point can be described by the horizon mentioned above. On the other hand, electronic horizon data having the second point as the starting point and the third point as the end point can be geographically connected to the foregoing electronic horizon data having the first point as the starting point and the second point as the end point.

The operation of generating electronic horizon data having the second point as the starting point and the third point as the end point can be applied with the foregoing electronic horizon data having the first point as the starting point and the second point as the end point.

In some implementations, the vehicle 100 can be driven even when the final destination is not set.

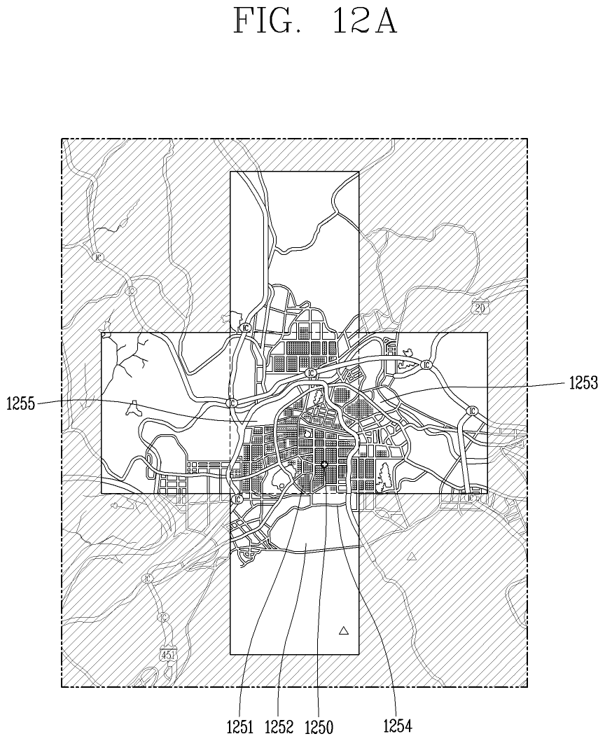

FIG. 13 is a flowchart for explaining a path providing method of the path providing device of FIG. 9.

The processor 830 receives a high-definition map from an external server (S1310).

The external server is an example of the telematics communication device 910 as a device capable of communicating through the first telecommunication control unit 812. The high-definition map is composed of a plurality of layers. Furthermore, the high-definition map can include at least one of the four layers described above with reference to FIG. 11B as an ADAS MAP.

The processor 830 can generate field-of-view for autonomous driving to guide a road located in the front of the vehicle in units of lanes using the high-definition map (S1330).

The processor 830 receives sensing information from one or more sensors provided in the vehicle 100 through the interface unit 820. The sensing information can be vehicle driving information.

The processor 830 can identify any one lane in which the vehicle is located on a road made up of a plurality of lanes based on an image received from an image sensor among the sensing information. For example, when the vehicle 100 is driving in a first lane on an 8-lane road, the processor 830 can identify the first lane as a lane in which the vehicle 100 is located based on the image received from the image sensor.

The processor 830 can estimate an optimal path that is expected or planned to move the vehicle 100 based on the identified lane in units of lanes using the map information.

In some examples, the optimal path can be referred to as a Most Preferred Path or Most Probable Path, and can be abbreviated as MPP. For example, the optimal path can be a route that other vehicles have taken to travel to the same or close destination of a vehicle among a plurality of routes to the destination. As another example, the optimal path can be a route that is expected to be available to guide the vehicle to a destination in a shortest driving distance or in a shortest driving time in consideration of the status of the route (e.g., accidents, constructions). In some cases, the optimal path can be a route that includes the least stops among a plurality of routes.

The vehicle 100 can drives autonomously along the optimal path. When driving manually, the vehicle 100 can provide navigation information that guides the optimal path to the driver.

The processor 830 can generate field-of-view information for autonomous driving in which the sensing information is merged into the optimal path. The field-of-view information for autonomous driving can be referred to as “eHorizon.”

The processor 830 can generate different field-of-view information for autonomous driving depending on whether or not a destination is set in the vehicle 100.

For example, when the destination is set in the vehicle 100, the processor 830 can generate field-of-view information for autonomous driving to guide a driving path to the destination in units of lanes.

As another example, when no destination is set in the vehicle 100, the processor 830 can calculate a main path (most preferred path, MPP) having the highest possibility that the vehicle 100 can drive, and generate field-of-view for autonomous driving to guide the main path (MPP) in units of lanes. In this case, the field-of-view information for autonomous driving can further include sub path information on sub paths branched from the most preferred path (MPP) for the vehicle 100 to be movable at a higher probability than a predetermined reference.

The field-of-view information for autonomous driving can be formed to provide a driving path to the destination for each lane indicated on a road, thereby providing more precise and detailed path information. It can be path information conforming to the standard of ADASIS v3.

The field-of-view information for autonomous driving can be provided by subdividing a path in which the vehicle must drive or a path in which the vehicle can drive in units of lanes. The field-of-view information for autonomous driving can be information for guiding a driving path to a destination in units of lanes. When the field-of-view information for autonomous driving is displayed on a display mounted on the vehicle 100, a guide line for guiding a lane that can be driven on the map can be displayed. Moreover, a graphic object indicating the location of the vehicle 100 can be included in at least one lane on which the vehicle 100 is located among a plurality of lanes included in the map.

Dynamic information that guides a movable object located on the optimal path can be merged into the field-of-view information for autonomous driving. The dynamic information can be received at the processor 830 through the telecommunication control unit 810 and/or the interface unit 820, and the processor 830 can update the optimal path based on the dynamic information. As the optimal path is updated, the field-of-view information for autonomous driving is also updated.

The dynamic information can be referred to as dynamic information, and can include dynamic data.

The processor 830 can provide the field-of-view information for autonomous driving to at least one electrical part provided in the vehicle (S1350). Moreover, the processor 830 can provide the field-of-view information for autonomous driving to various applications installed in the system of the vehicle 100.

The electrical part refers to any device mounted on the vehicle 100 to allow communication, and can include the components 120-700 described above with reference to FIG. 7. For example, an object detecting apparatus 300 such as a radar and a lidar, a navigation system 770, a vehicle operating apparatus 600, and the like can be included in the electrical part.

The electrical part can perform its own function to be carried out based on the field-of-view information for autonomous driving.

The field-of-view information for autonomous driving can include a path in units of lanes and a location of the vehicle 100, and can include dynamic information including at least one object that must be sensed by the electrical part. The electrical part can reallocate a resource to sense an object corresponding to the dynamic information, determine whether the dynamic information matches sensing information sensed by itself, or change a setting value for generating sensing information.

The field-of-view information for autonomous driving can include a plurality of layers, and the processor 830 can selectively transmit at least one of the layers according to an electrical part that receives the field-of-view information for autonomous driving.

Specifically, the processor 830 can select at least one of a plurality of layers included in the field-of-view information for autonomous driving, based on at least one of a function being executed by the electrical part and a function scheduled to be executed. In some cases, the processor 830 can transmit the selected layer to the electronic part, but the unselected layer may not be transmitted to the electrical part.

The processor 830 can receive external information generated by an external device from the external device located within a predetermined range with respect to the vehicle.

The predetermined range is a distance at which the second telecommunication control unit 914 can perform communication, and can vary according to the performance of the second telecommunication control unit 914. When the second telecommunication control unit 914 performs V2X communication, a V2X communication range can be defined as the predetermined range.

In some examples, the predetermined range can vary according to an absolute speed of the vehicle 100 and/or a relative speed with respect to the external device.

The processor 830 can determine the predetermined range based on the absolute speed of the vehicle 100 and/or the relative speed with respect to the external device, and allow communication with an external device located within the determined predetermined range.

Specifically, external devices capable of communicating through the second telecommunication control unit 914 can be classified into a first group or a second group based on the absolute speed of the vehicle 100 and/or the relative speed with respect to the external device. External information received from an external device included in the first group is used to generate dynamic information described below, but external information received from an external device included in the second group is not used to generate the dynamic information. Even when external information is received from an external device included in the second group, the processor 830 ignores the external information.

The processor 830 can generate dynamic information of an object that must be sensed by at least one electrical part provided in the vehicle based on the external information, and can match the dynamic information to the field-of-view information for autonomous driving.

For example, the dynamic information can correspond to the fourth layer described above with reference to FIGS. 11A and 11B.

As described above in FIGS. 11A and 11B, the path providing device 800 can receive ADAS MAP and/or LDM data. Specifically, the ADAS MAP can be received from the telematics communication device 910 through the first telecommunication control unit 812 and the LDM data can be received from the V2X communication device 920 through the second telecommunication control unit 814.

The ADAS MAP and the LDM data can be composed of a plurality of layers having the same format. The processor 830 can select at least one layer from the ADAS MAP, select at least one layer from the LDM data, and generate the field-of-view information for autonomous driving composed of the selected layers.

For example, the processor 830 can select the first to third layers of the ADAS MAP, select the fourth layer of the LDM data, and generate one field-of-view information for autonomous driving in which four layers are combined into one. In this case, the processor 830 can transmit a reject message for rejecting the transmission of the fourth layer to the telematics communication device 910. It is because the first telecommunication control unit 812 uses less resources to receive some information excluding the fourth layer than to receive all the information including the fourth layer. Part of the ADAS MAP can be combined with part of the LDM data to use mutually complementary information.

In some examples, the processor 830 can select the first to fourth layers of the ADAS MAP, select the fourth layer of the LDM data, and generate one field-of-view information for autonomous driving in which five layers are combined into one. In this case, priority can be given to the fourth layer of the LDM data. When there is discrepancy information that does not match the fourth layer of the LDM data in the fourth layer of the ADAS MAP, the processor 830 can delete the discrepancy information or correct the discrepancy information based on the LDM data.

The dynamic information can be object information for guiding a predetermined object. For example, at least one of a location coordinate for guiding the location of the predetermined object, and information for guiding the shape, size, and type of the predetermined object can be included in the dynamic information.

The predetermined object can denote an object that obstructs driving in the corresponding lane among objects that can drive on a road.

For example, the predetermined object can include a bus stopping at a bus stop, a taxi stopping at a taxi stop, a truck dropping a courier, and the like.

As another example, the predetermined object can include a garbage collection vehicle driving at a constant speed or below, or a large vehicle (e.g., truck or container truck, etc.) determined to obstruct view.

For still another example, the predetermined object can include an object indicating an accident, road damage, or construction.

As described above, the predetermined object can include all types of objects disallowing the driving of the present vehicle 100 or obstructing the lane not to allow the vehicle 100 to drive. Traffic signals such as ice roads, pedestrians, other vehicles, construction signs, and traffic lights to be avoided by the vehicle 100 can correspond to the predetermined object and can be received by the path providing device 800 as the external information.

In some implementations, the processor 830 can determine whether a predetermined object guided by the external information is located within a reference range based on the driving path of the vehicle 100.

Whether or not the predetermined object is located within the reference range can vary depending on the lane on which the vehicle 100 drives and the location of the predetermined object.

For example, external information for guiding a sign indicating the construction of a third lane ahead 1 km while driving on a first lane can be received. When the reference range is set to 1 m with respect to the vehicle 100, the sign is located out of the reference range. It is because when the vehicle 100 continues to drive on the first lane, the third lane is located out of 1 m with respect to the vehicle 100. On the contrary, when the reference range is set to 10 m with respect to the vehicle 100, the sign is located within the reference range.

The processor 830 generates the dynamic information based on the external information when the predetermined object is located within the reference range, but does not generate the dynamic information when the predetermined object is located out of the reference range. In other words, the dynamic information can be generated only when the predetermined object guided by the external information is located on a driving path of the vehicle 100 or within a reference range capable of affecting the driving path of the vehicle 100.

In some implementations, the path providing device can combine information received through the first telecommunication control unit and information received through the second telecommunication control unit into one information during the generation of field-of-view information for autonomous driving, and thus optimal field-of-view information for autonomous driving can include information that is provided through different telecommunication control units and mutually complemented. For example, when the information received through the first telecommunication control unit has a restriction in that it is unable to reflect the information in real time, the information received through the second telecommunication control unit can complement the real-time property.

Further, since when there is information received through the second telecommunication control unit, the processor 830 controls the first telecommunication control unit so as not to receive the corresponding information, it can be possible to use the bandwidth of the first telecommunication control unit less than the related art. In other words, the resource use of the first telecommunication control unit can be minimized.

When a collision occurs in the vehicle, the processor 830 can control the interface unit to drive along the emergency path (S1370).

The processor 830 can check or determine whether a collision has occurred in the vehicle 100 based on vehicle driving information received through the interface unit 820.

Furthermore, when a failure occurs in one or more electrical parts provided in the vehicle 100, the processor 830 can determine that a collision has occurred in the vehicle 100.

The processor 830 can check or calculate a location of the collision and an amount of impact based on vehicle driving information.

The processor 830 can determine a driving enabled state of the vehicle 100 to set the emergency path based on the driving enabled state.

The driving enabled state can be defined as at least one of a driving enabled direction, a driving disabled direction, and a driving enabled speed. For example, the driving enabled direction can be defined as a direction in which the vehicle 100 is able to move in a full range of 360 degrees with respect to a point of the vehicle. The driving disabled direction can be defined as a direction in which the vehicle 100 is unable to move in the full range of 360 degrees.

The emergency path is compared with the optimal path, and refers to a path for moving the vehicle 100 to a safe place without an accident risk. For reference, the optimal path denotes a path for which the movement of the vehicle 100 is expected or planned.

More specifically, the emergency path is set for a predetermined area within 1 km based on the current location of the vehicle 100, and defined as a path capable of safely and quickly moving the vehicle 100 to an emergency destination for parking the vehicle 100 from the current location.

The emergency destination is a place where the vehicle 100 is allowed to park, and is defined as a place where the possibility of a secondary accident caused by another vehicle is minimized.

The processor 830 controls the interface unit 820 to drive along the emergency path when a collision occurs in the vehicle.

In CAN communication, the emergency path can have a higher priority than the optimal path. In other words, a message related to the emergency path can have a higher priority than a message related to the optimal path.

In response to generating the emergency path, the driving path of the vehicle 100 is changed from the optimal path to the emergency path.

For example, the vehicle 100 can start forced autonomous driving on the emergency path regardless of the driver's intention. The forced autonomous driving can continue until the vehicle 100 stops at the emergency destination set in the emergency path.

The emergency path can include a control command forcing to vary at least one of a driving direction and a driving speed of the vehicle so as to perform the forced autonomous driving.

As another example, the vehicle 100 can provide a user interface for suggesting changing the optimal path to the emergency path to the passenger.

When the emergency path is generated, the processor 830 can control the interface unit 820 to delete an optimal path that has been previously transmitted. For example, the image sensor can store the optimal path in its own memory. The image sensor can delete the optimal path stored in a memory, and store the emergency path in response to the generation of the emergency path.

The processor 830 can determine whether the movement of the vehicle 100 to the emergency path is allowed, and when the movement is not allowed, the processor 830 can control the telecommunication control unit 810 to output dynamic information that guides the lane where the vehicle 100 is located. For example, when the vehicle 100 is located in a seventh lane on an 8-lane road, the seventh lane can be specified as an accident lane, and guide information indicating that the vehicle 100 is located in the seventh lane can be broadcast. Since dynamic information is selectively output according to whether or not it is allowed to move, unnecessary dynamic information can prevented from being generated.

The processor 830 can broadcast emergency path information corresponding to the emergency path through the telecommunication control unit 810. For example, emergency path information corresponding to the emergency path can be generated as dynamic information and transmitted to the telematics communication device 910 through the first telecommunication control unit 812, or transmitted to the V2X communication device 930 through the second telecommunication control unit 814.

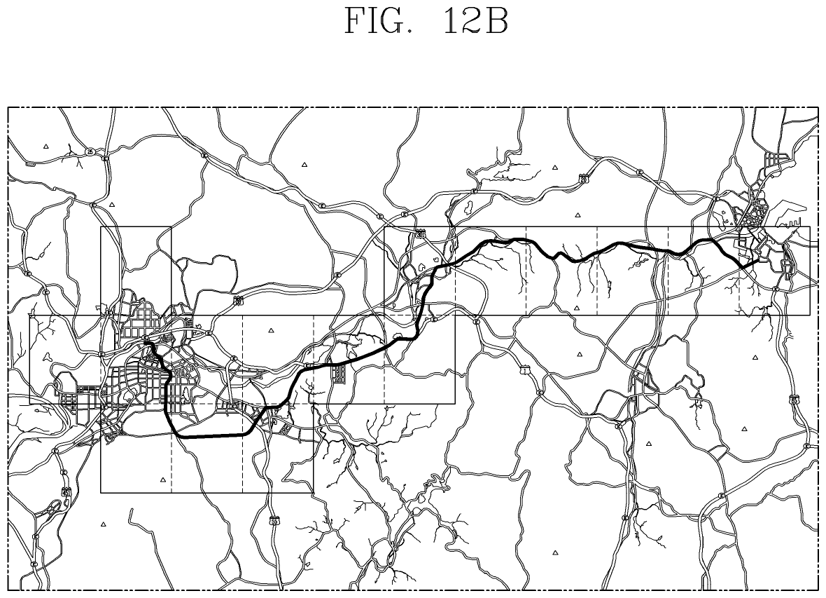

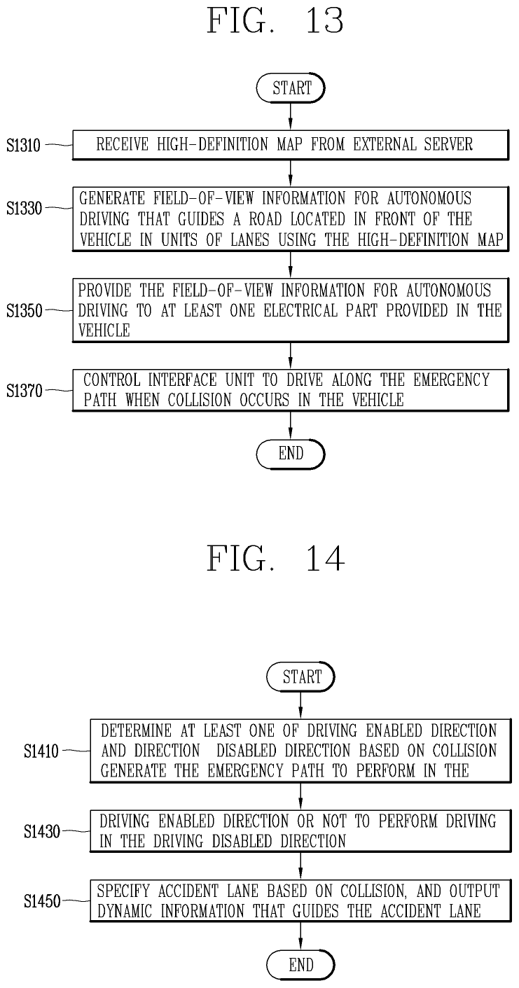

FIG. 14 is a flowchart for explaining a method of generating an emergency path by a path providing device. Furthermore, FIGS. 15A and 15B are exemplary views for explaining the implementations of FIG. 14.

The processor 830 can determine at least one of a driving enabled direction and a driving disabled direction based on a collision (S1410).

The collision refers to colliding between a predetermined object and the vehicle 100. When a collision occurs in the vehicle 100, there is a high probability that a device such as a sensor disposed in a collision region has failed due to a force applied to the collision region. Moreover, there is a high possibility that a predetermined object in which a collision has occurred is located at an opposite side to the collision region.

The processor 830 can check or calculate an impact location and an impact amount of a collision based on vehicle driving information received through the interface unit 820. The processor 830 can specify a collision region for the vehicle 100 based on at least one of the impact location and the impact amount. The processor 830 can generate collision information for guiding the impact location, the impact amount, and collision region.

The processor 830 can divide a full range of 360 degrees into a sensing enabled region and a sensing disabled region with respect to a point of the vehicle. When a collision occurs, the processor 830 can test one or more sensors included in the vehicle 100. For example, the processor 830 can present a test task to be solved by the sensor, and determine whether the sensor has failed based on whether an answer corresponding to the task is received from the sensor, and whether the answer is correct.

The processor 830 can determine a failure sensor based on the collision among a plurality of sensors provided in the vehicle, and determine the sensing enabled region and the sensing disabled region based on the failure sensor. The driving disabled direction can be determined by the failure sensor.

The processor 830 can determine a sensing enabled region and a sensing disabled region based on sensors other than a failure sensor among the sensors provided in the vehicle 100. The sensing enabled region is used to define the driving enabled direction, and the sensing disabled region is used to define the driving disabled direction.

The processor 830 can generate the emergency path to perform driving in the driving enabled direction or not to perform driving in the driving disabled direction (S1430).

The emergency path can be generated as a path that moves only in the driving enabled direction or a path that does not move in the driving disabled direction.

The processor 830 can search for a road traffic law prescribed for a road on which the vehicle is driving, and generate the emergency path within a range that complies with the road traffic law.

The processor 830 can generate the emergency path within a range that complies with the road traffic law when there is a movable object within a predetermined range based on the vehicle 100, and generate the emergency path regardless of the road traffic law when there is no movable object within the predetermined range.

For example, as illustrated in FIG. 15A, a collision with a preceding vehicle can occur while the vehicle 100 is driving on a one-way one-lane road (or a two-way two-lane road). In this case, the processor 830 can divide a predetermined range with respect to the current position of the vehicle 100 into a driving enabled region 1510 and a driving disabled region 1520 based on the field-of-view information for autonomous driving. The driving enabled region 1510 and the driving disabled region 1520 can vary according to a road traffic law in a country where the vehicle 100 is driving. The processor 830 can search for an emergency destination in the driving enabled region, 1510 and generate an emergency path 1530 to the emergency destination.

As another example, as illustrated in FIG. 15B, another vehicle 1540 can be approaching from the rear in a lane where the vehicle 100 is driving, or a pedestrian 1550 can be located on the shoulder. In this case, the processor searches for whether there is a movable object within a predetermined range based on dynamic information included in the field-of-view information for autonomous driving. When there is no movable object, an emergency path can be generated regardless of the road traffic law. As a result, the driving enabled region 1512 and the driving disabled region 1522 can be set differently from the example illustrated in FIG. 15A. In other words, even though a collision occurs at the same location, the driving enabled region and the driving disabled region can be varied according to the presence or absence of a movable object to vary the emergency path 1560.

The processor 830 can specify an accident lane based on a collision, and output dynamic information that guides the accident lane (S1450).

The processor 830 can specify one or more lanes where the vehicle 100 is located as an accident lane based on a collision, and control the telecommunication control unit 810 to output dynamic information that guides the accident lane.

A path providing device according to the present disclosure can generate an emergency path within a range that complies with the road traffic law. However, when safety is secured because there is no movable object in exceptional circumstances, an emergency path can be generated regardless of the road traffic law.

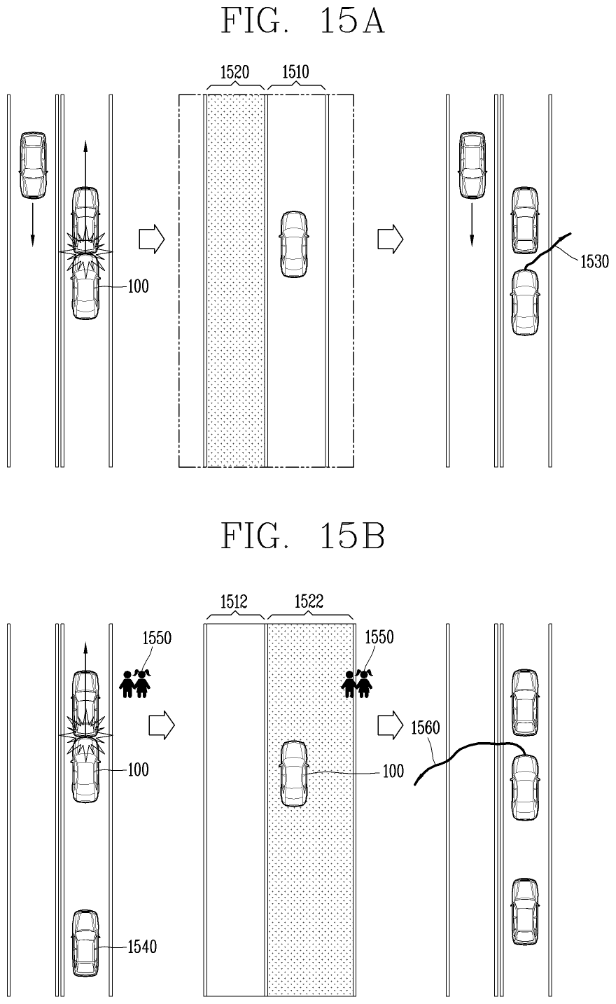

FIG. 16 is a flowchart for explaining a method of determining at least one of a failure sensor and an emergency path sensor based on a collision.

The processor 830 can determine at least one of a failure sensor and an emergency path sensor among a plurality of sensors provided in the vehicle 100 based on the collision (S1610).

At least one of a failure sensor and an emergency path sensor can be determined based on the collision information described above in FIG. 13. The emergency path sensor can be varied according to at least one of a location of the collision and an amount of impact.

Based on the collision information, the processor 830 can classify a full range of 360 degrees into a sensing enabled region and a sensing disabled region with respect to a point of the vehicle based on the collision. In addition, the emergency path sensor can be selected based on the sensing enabled region. For example, a sensor disposed in the sensing enabled region can be selected as the emergency path sensor.

The processor 830 can execute a function related to at least one of a failure sensor and an emergency path sensor (S1630).

For example, the processor 830 can generate the emergency path using sensing information generated by the emergency path sensor. The destination of the emergency path can vary according to the emergency path sensor. For example, when a rear image sensor is determined as an emergency path sensor, an emergency path moving in a reverse direction is set using a reverse gear. As another example, when the front image sensor is determined as an emergency path sensor, an emergency path moving in a forward direction is set using a forward gear.

The processor 830 can generate a plurality of emergency path candidates that can be driven by using sensors disposed in the sensing enabled region. The processor 830 can calculate an evaluation score according to an evaluation item previously set for each emergency path candidate. The evaluation item can include at least one of a moving time and the number of emergency path sensors that must be essentially used when moving to an emergency path.

For example, when the number of emergency path sensors required to drive a first emergency path candidate is 10 and the number of emergency path sensors required to drive a second emergency path candidate is one, the processor 830 can select the second emergency path candidate.

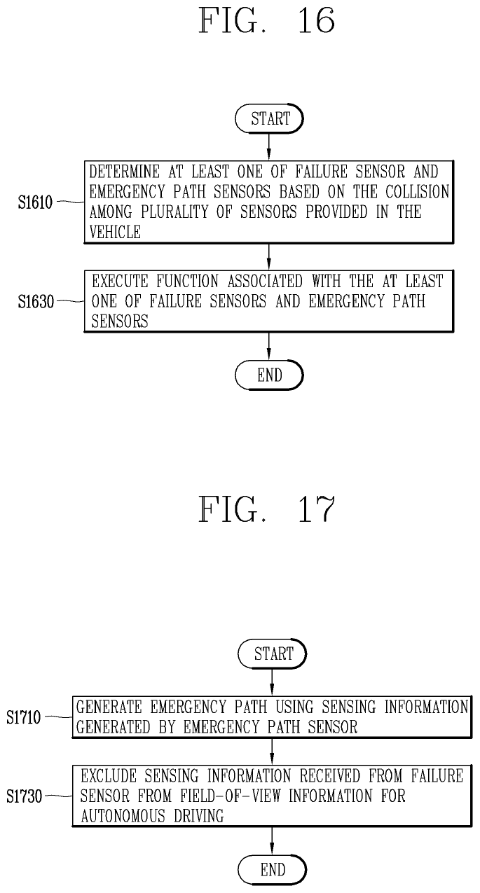

FIG. 17 is a flowchart explaining a method of using at least one of a failure sensor and an emergency path sensor.

An emergency path is generated using sensing information generated by the emergency path sensor (S1710).

When an emergency path is generated, the processor 830 can activate an essential sensor required for the emergency path, and deactivate the other sensors. Alternatively, the processor 830 can perform driving on an emergency path using only information provided by the essential sensor. Since an emergency path candidate requiring a minimum number of sensors is selectively used, a minimum amount of resources can be used in an emergency situation.

The processor 830 can exclude sensing information received from the failure sensor from the field-of-view information for autonomous driving (S1730). Furthermore, the processor 830 can control the interface unit 820 so as not to allow the failure sensor to transmit sensing information.

Since the information generated by the failure sensor is not merged with the field-of-view information for autonomous driving, unnecessary information may not be merged with the field-of-view information for autonomous driving, and data size can be reduced to efficiently use resources.

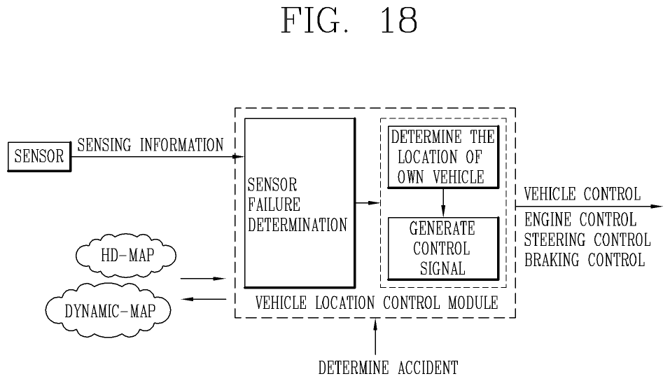

FIG. 18 is a block diagram of a path providing device capable of generating an emergency path.

The path providing device 800 includes a sensor failure determination unit that determines a failure of a sensor. The sensor failure determination unit determines whether each sensor has a failure using sensing information received from the sensor.

When it is determined that a collision has occurred, the processor 830 generates an emergency path based on the location of the own vehicle, and performs vehicle control so as to perform driving to the emergency path. For example, at least one of engine control, steering control, and braking control can be performed based on the emergency path.

The foregoing present disclosure can be implemented as codes (an application or software) readable by a computer on a medium written by the program. The control method of the above-described autonomous vehicle can be implemented by codes stored in a memory or the like.

The computer-readable media can include all kinds of recording devices in which data readable by a computer system is stored. Examples of the computer-readable media can include ROM, RAM, CD-ROM, magnetic tape, floppy disk, and optical data storage device, and the like, and also include a device implemented in the form of a carrier wave (for example, transmission via the Internet). In addition, the computer can include a processor or controller. Accordingly, the detailed description thereof should not be construed as restrictive in all aspects but considered as illustrative. The scope of the invention should be determined by reasonable interpretation of the appended claims and all changes that come within the equivalent scope of the invention are included in the scope of the invention.

What is claimed is:

1. A path providing device configured to provide path information to a vehicle, the path providing device comprising:
a telecommunication control unit configured to receive map information comprising a plurality of layers of data from a server;
an interface unit configured to receive sensing information from one or more sensors disposed at the vehicle, the sensing information comprising an image received from an image sensor among the one or more sensors; and
a processor configured to:
based on the sensing information, identify a lane in which the vehicle is located among a plurality of lanes of a road,
determine an optimal path for guiding the vehicle from the identified lane, the optimal path comprising one or more lanes included in the map information,
based on the sensing information and the optimal path, generate field-of-view information for autonomous driving, and transmit the field-of-view information to at least one of the server or an electrical component disposed at the vehicle,
merge the field-of-view information with dynamic information related to a movable object located on the optimal path,
update the optimal path based on the dynamic information,
in response to an occurrence of a collision of the vehicle on the optimal path, generate an emergency path based on the field-of-view information, the emergency path being different from the optimal path, and
control the interface unit to guide the vehicle along the emergency path.

2. The path driving device of claim 1, wherein the processor is configured to:
determine at least one of a driving enabled direction and a driving disabled direction based on the collision, and
generate the emergency path to guide the vehicle in the driving enabled direction.

3. The path driving device of claim 2, wherein the processor is configured to:
based on the collision, determine a failure sensor among the one or more sensors disposed at the vehicle, and
determine the driving disabled direction based on failure sensing information received from the failure sensor.

4. The path driving device of claim 3, wherein the processor is configured to exclude the failure sensing information from the sensing information for generating the field-of-view information.

5. The path driving device of claim 4, wherein the processor is configured to control the interface unit to restrict transmission of the failure sensing information from the failure sensor.

6. The path driving device of claim 1, wherein the processor is configured to:
search for a road traffic law prescribed for the road on which the vehicle is driving; and
generate the emergency path based on the road traffic law.

7. The path driving device of claim 6, wherein the processor is configured to:
based on the movable object being present within a predetermined range from the vehicle, generate the emergency path within a range that complies with the road traffic law; and
based on the movable object not being present within the predetermined range from the vehicle, generate the emergency path regardless of the road traffic law.

8. The path driving device of claim 1, wherein the processor is configured to set the emergency path to have a higher priority than the optimal path.

9. The path driving device of claim 1, wherein the processor is configured to, based on the emergency path being generated, control the interface unit to cancel the optimal path that was previously transmitted.

10. The path driving device of claim 1, wherein the emergency path comprises a control command for controlling at least one of a driving direction or a driving speed of the vehicle.

11. The path driving device of claim 1, wherein the processor is configured to:
based on the collision, select an emergency path sensor among the one or more sensors disposed at the vehicle; and
generate the emergency path based on emergency sensing information generated by the emergency path sensor.

12. The path driving device of claim 11, wherein the processor is configured to:
based on the collision, divide a range of 360 degrees with respect to a point of the vehicle into a sensing enabled region and a sensing disabled region, and
select the emergency path sensor based on the sensing enabled region.

13. The path driving device of claim 11, wherein the processor is configured to determine a destination of the emergency path based on the emergency path sensor.

14. The path driving device of claim 11, wherein the processor is configured to vary the emergency path sensor based on at least one of a location of the collision or an impact of the collision.

15. The path driving device of claim 1, wherein the processor is configured to:
based on the collision of the vehicle, identify an accident lane among the plurality of lanes of the road; and
control the telecommunication control unit to output the dynamic information that indicates the accident lane.

16. The path driving device of claim 15, wherein the processor is configured to:
based on the collision of the vehicle, determine whether the vehicle is able to move to the emergency path; and
based on determining that the vehicle is unable to move to the emergency path, control the telecommunication control unit to output the dynamic information that indicates the accident lane.

17. A method for providing path information to a vehicle, the method comprising:
receiving map information comprising a plurality of layers of data from a server;
receiving sensing information from one or more sensors disposed at the vehicle, the sensing information comprising an image received from an image sensor among the one or more sensors;
based on the sensing information, identifying a lane in which the vehicle is located among a plurality of lanes of a road;
determining an optimal path for guiding the vehicle from the identified lane, the optimal path comprising one or more lanes included in the map information;
generating field-of-view information for autonomous driving based on the sensing information and the optimal path, and transmitting the field-of-view information to at least one of the server or an electrical component disposed at the vehicle;
merging the field-of-view information with dynamic information related to a movable object located on the optimal path;
updating the optimal path based on the dynamic information;
in response to an occurrence of a collision of the vehicle on the optimal path, generating an emergency path based on the field-of-view information, the emergency path being different from the optimal path; and
controlling the vehicle to drive along the emergency path.

18. The method of claim 17, wherein generating the emergency path comprises:
based on the collision, determining at least one of a driving enabled direction or a driving disabled direction; and
generating the emergency path to guide the vehicle in the driving enabled direction.

19. The method of claim 18, further comprising:
based on the collision, determining a failure sensor among the one or more sensors disposed at the vehicle; and
determining the driving disabled direction based on failure sensing information received from the failure sensor.

20. The method of claim 19, further comprising:
excluding the failure sensing information from the sensing information for generating the field-of-view information.
